(19) United States
(12) Patent Application Publication
(10) Pub. No.: US 2012/0240760 A1
(43) Pub. Date: Sep. 27, 2012

(54) Firearm having an articulated bolt train with transversally displacing firing mechanism, delay blowback breech opening, and recoil damper

(76) Inventor: Jorge Pizano, Cordova, TN (US)

(21) Appl. No.: 13/385,262

(22) Filed: Feb. 10, 2012

Related U.S. Application Data
(60) Provisional application No. 61/463,034, filed on Feb. 11, 2011.

(51) Int. Cl. F41A 5/18; B23P 11/00

(52) U.S. Cl. 89/191.01; 29/428

(57) ABSTRACT

This invention is about a firearm having an Articulated Bolt Train Assembly consisting of a series of linked carriages, containing mechanisms, displacing along non parallel tracks guides placed inside a by design Jaw Articulated Receiver that controls and governs its divergent paths, and holds all the sub assemblies in the convenient location allowing the synchronic movements of all the components to take place. The alternate divergent and converging motion of the Bolt Train Assembly and the Firing Mechanism, along, both, a bore axial path, and a transverse path, modifies the bearing of the recoil force, conveying a unique dynamic behavior, while performing different functions and achieving different purposes. In addition, the interaction of several components produce delay in the breech opening, and decelerate the rearwards motion to help, even more, the recoil damping. This invention has relevant consequences associated with the increased performance of firearms in civilian or military uses.

### CROSS REFERENCE TO RELATED APPLICATIONS

This Application claims the benefit of Provisional Patent Application Ser. No. 61/463,034 filed on Feb. 11, 2011 by the present inventor.

### TERMS DEFINITION

Train is a series of linked carriages that move along a track in a reciprocating manner.

The terms Articulated Bolt Train, Articulated Bolt, Bolt Train, Bolt Train sub assembly, Bolt Train Assembly, Bolt Train Mechanism, are used indistinctively The terms Front Bolt, Head Bolt, and Bolt refer to the first member of the Bolt Train. These terms may be used alternatively.

The terms Axial Force or axial recoil force refer to that one occurring in the direction of the axis of the barrel of the firearm or bore axis when the firearm is discharged.

The terms Carrier, Carriage, Carrier Housing, Mechanism Carriage Housing, refer to hollow, track mounted box, capable of containing and controlling mechanisms placed within, are used indistinctively.

The term forward direction is referred as the one having the direction of the projectile when fired.

The term rearward direction is the one opposite to forward or muzzle wards.

The term transverse is used to define a course oblique to the bore axis of the barrel.

The term Hammer is used to designate a moving part propelled linearly at the impulse of a spring. This can be also referred as a Striker, or slide striker hammer.

The terms Slot tracks guides, and Slot channel guides are used indistinctively.

The terms Charging handle and Cocking handle are used indistinctively.

The term Protruding Guides us used to refer to the protruding elements that run and slide into the Slot tracks guides.

The term Trunnion is used to refer to a part where the barrel is mounted, and in turn it is mounted to the receiver.

### BACKGROUND OF INVENTION

1. Field

This invention generally relates to a firearm having a collection of mechanisms and arrays, conceived to manage recoil by changing the dynamic behavior of the weapon when firing, in a manner that redirects forces, creates delays, decelerates motion, and lowers significantly the center of gravity, resulting in an improvement of the handling of the gun.

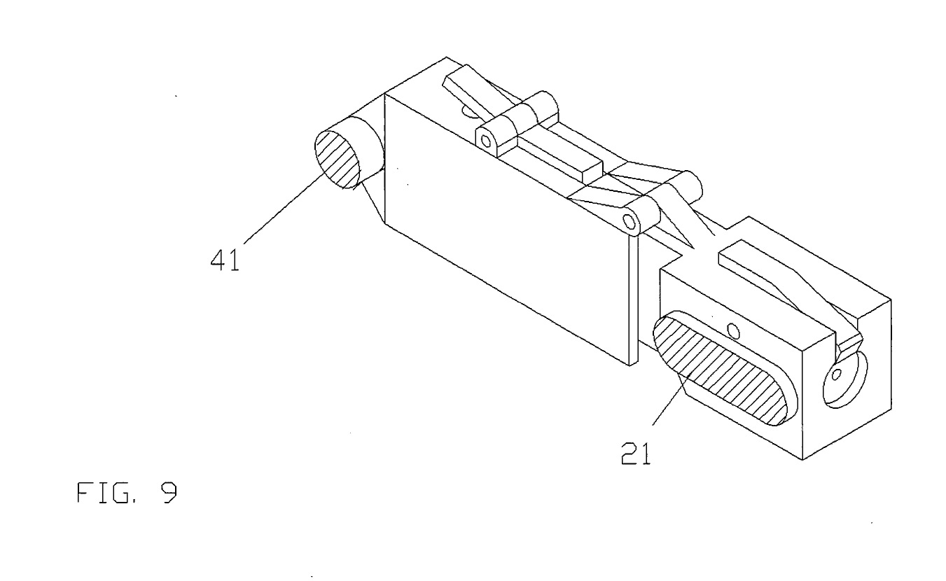

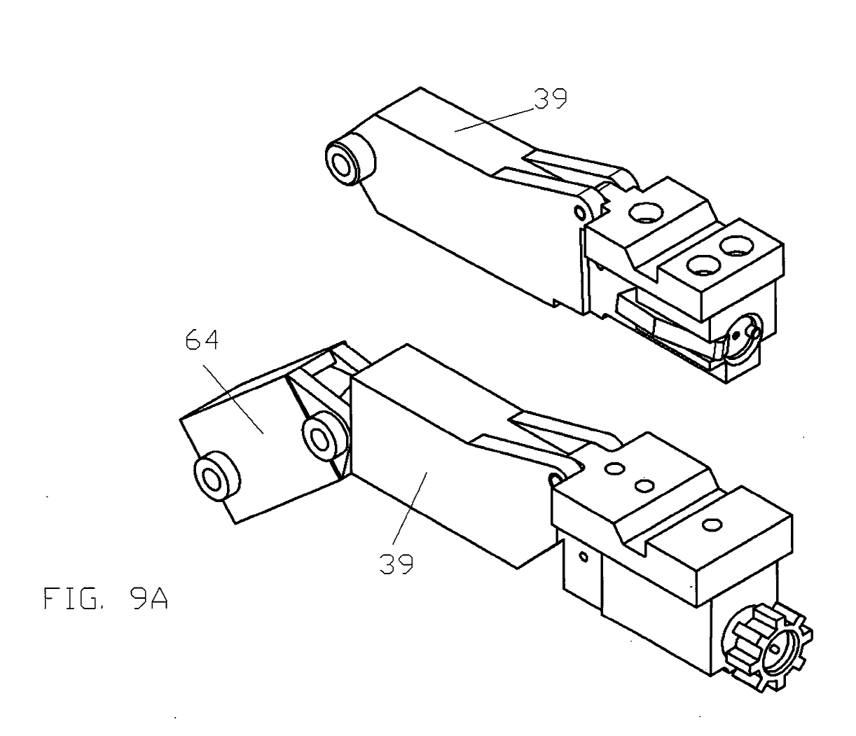

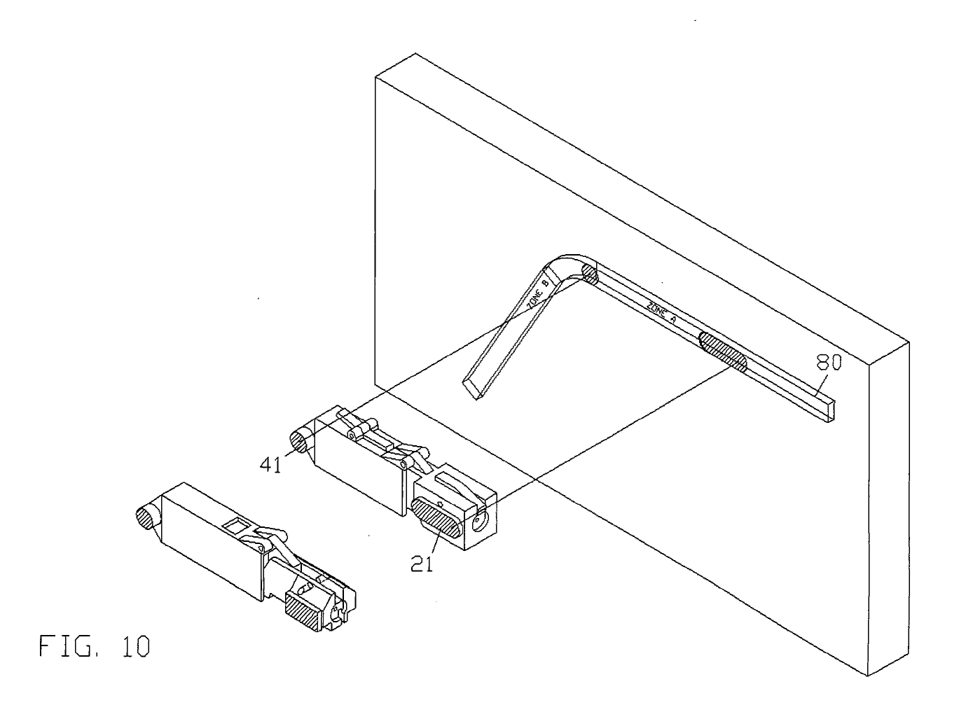

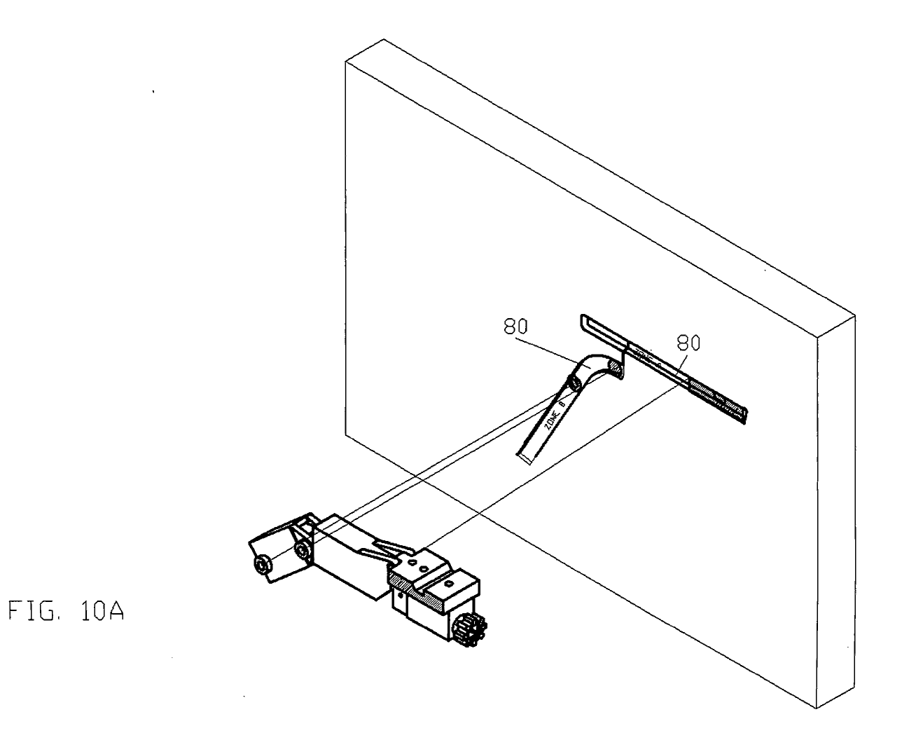

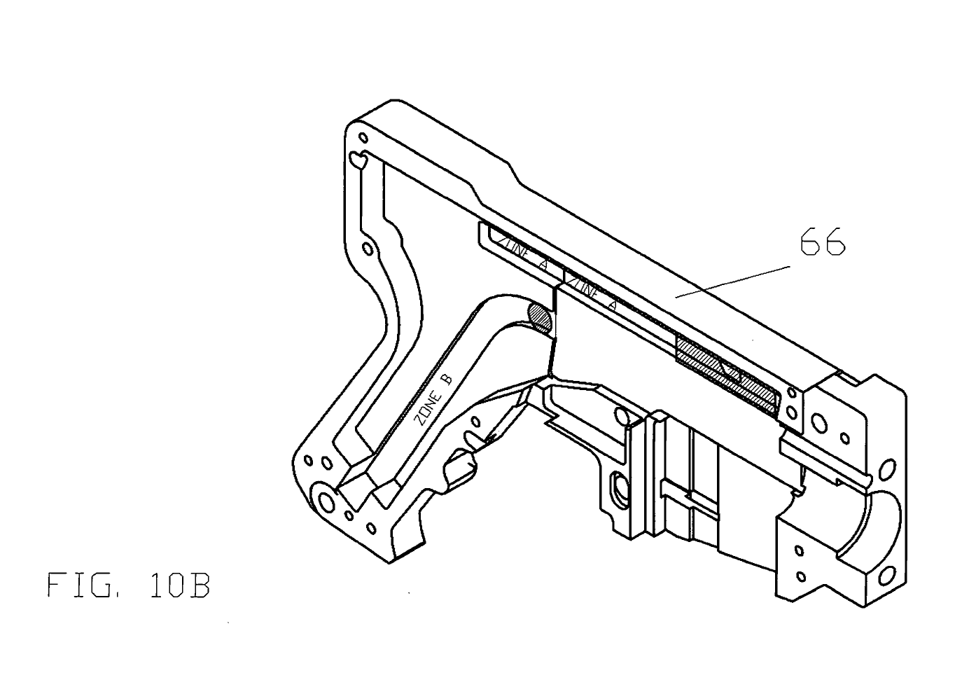

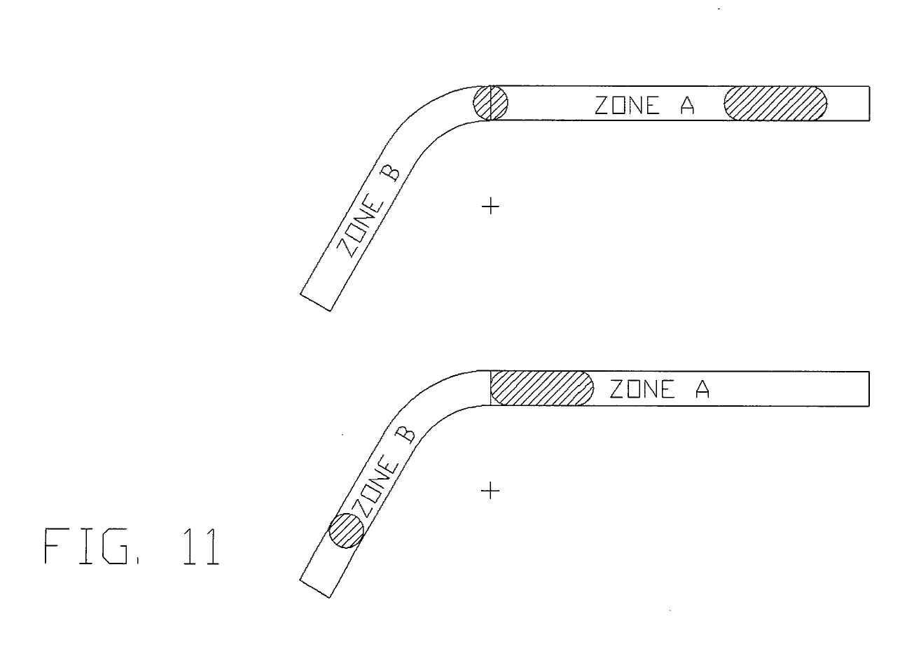

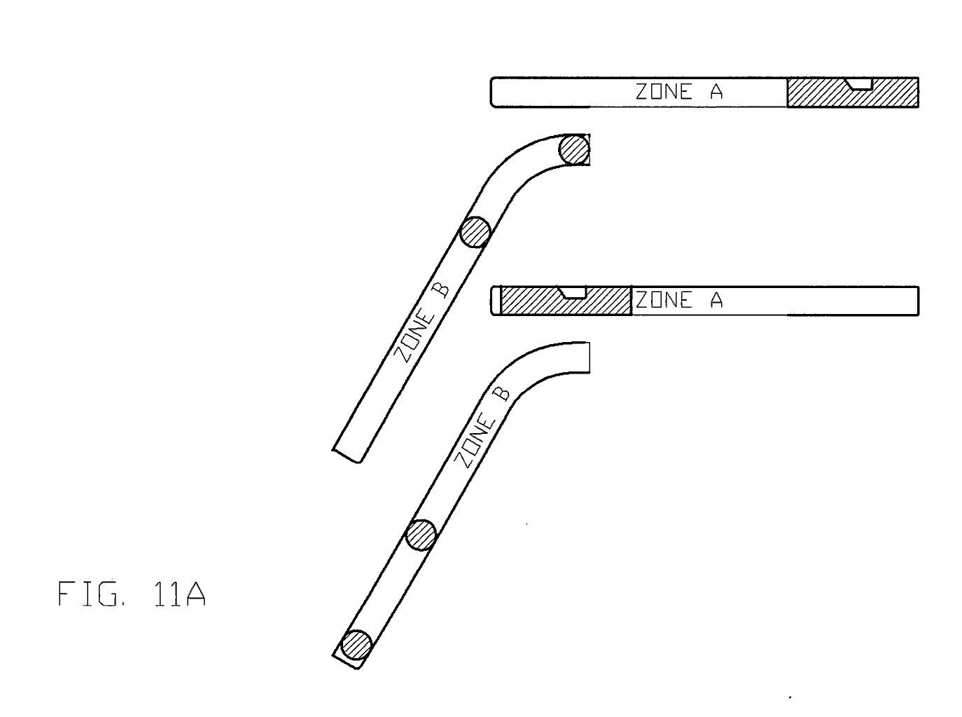

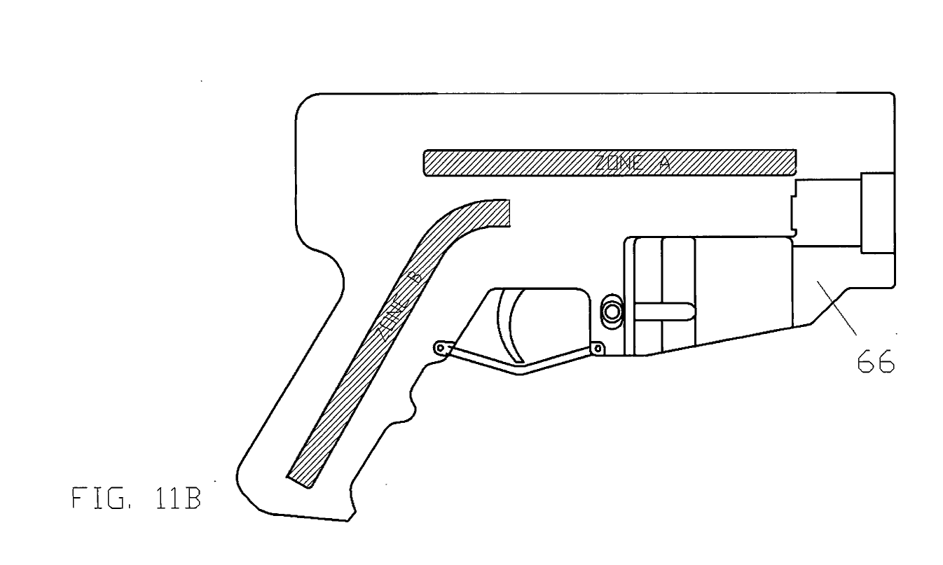

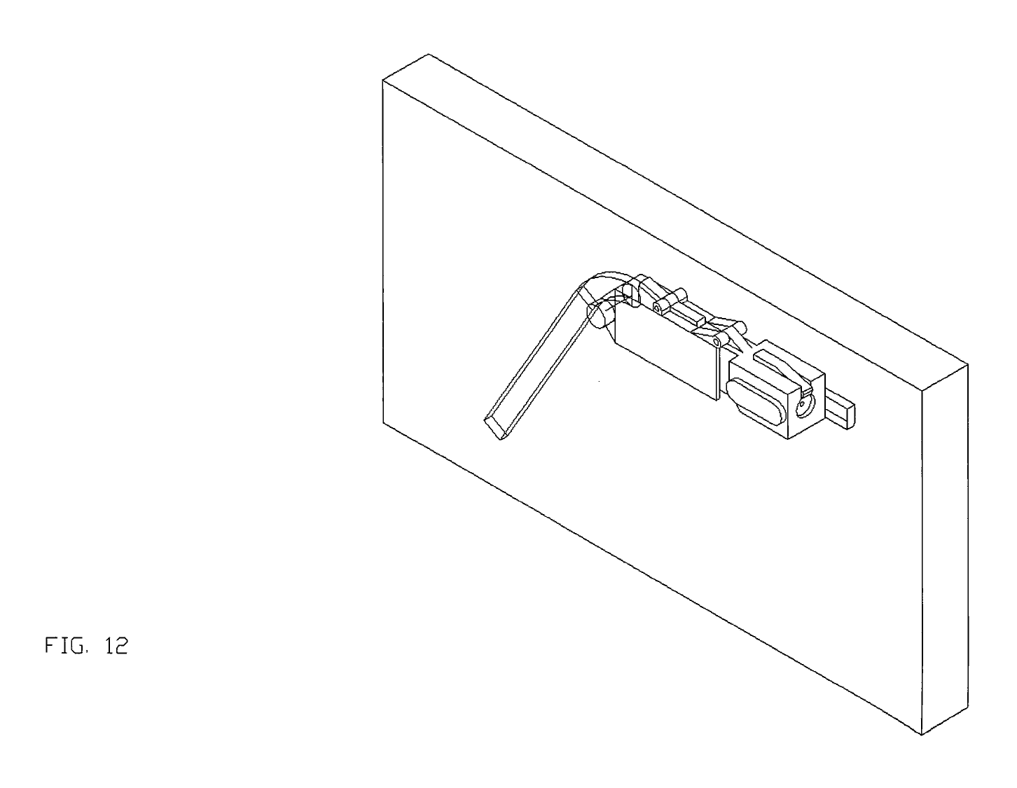

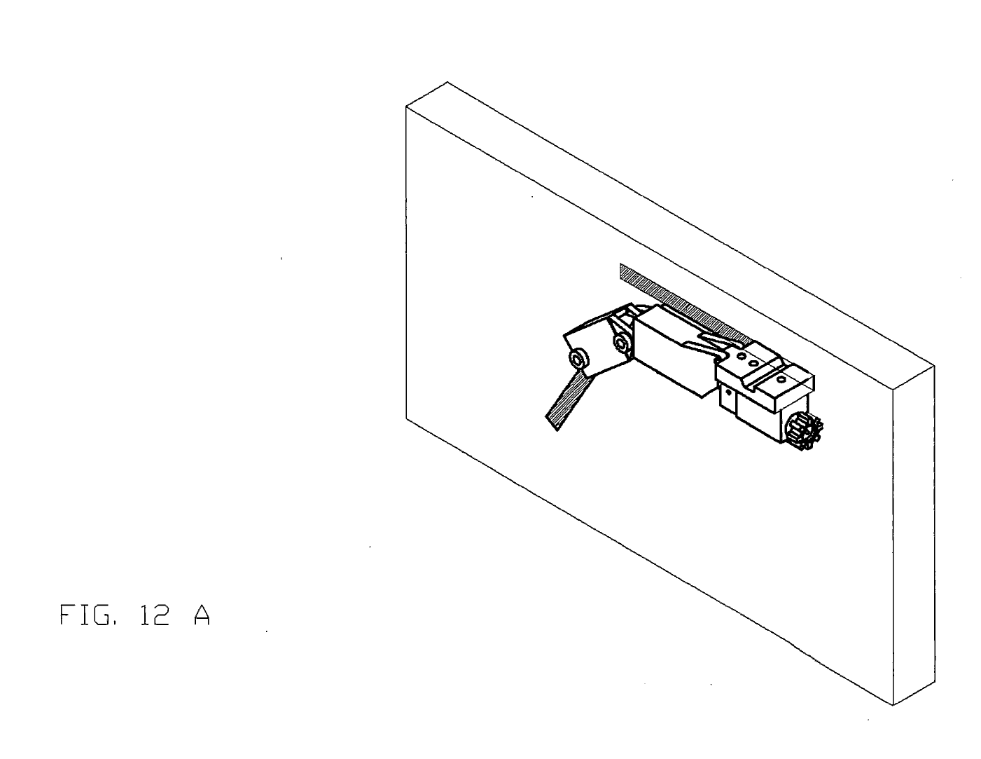

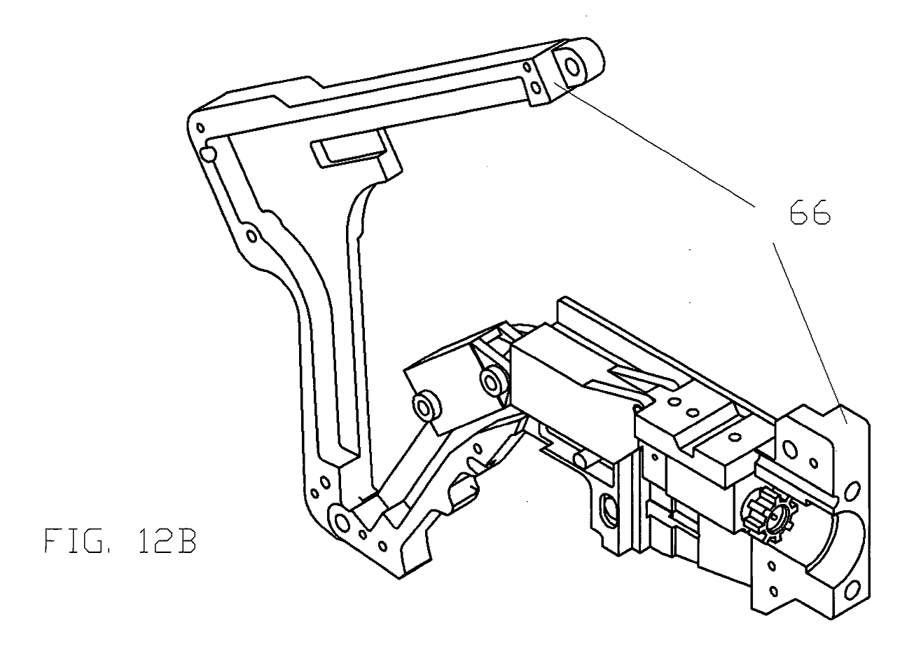

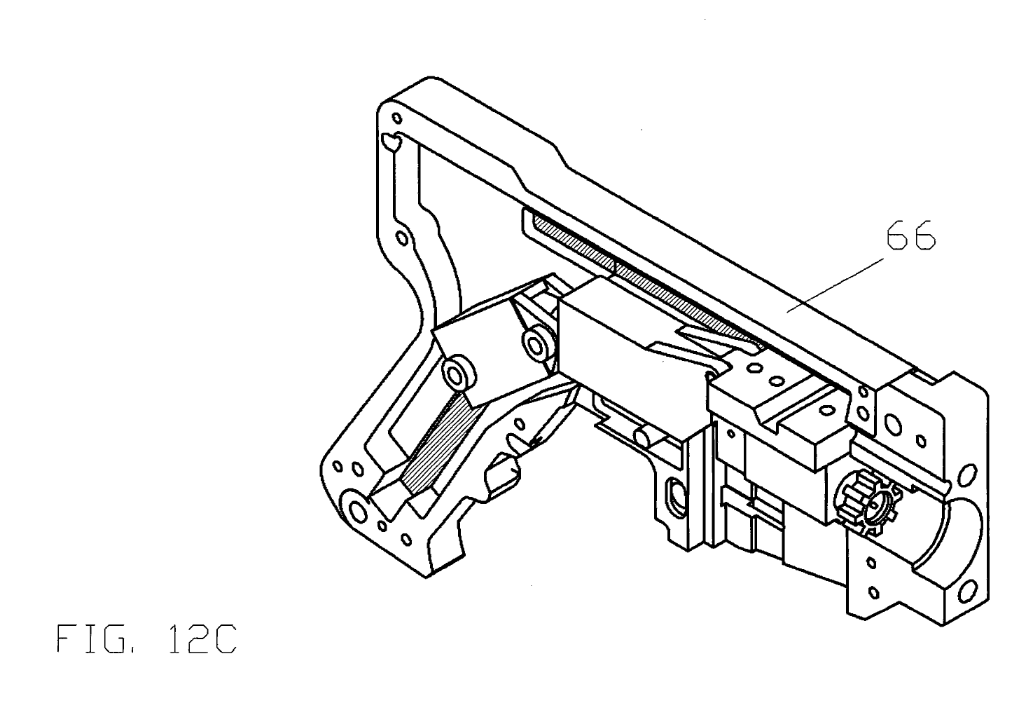

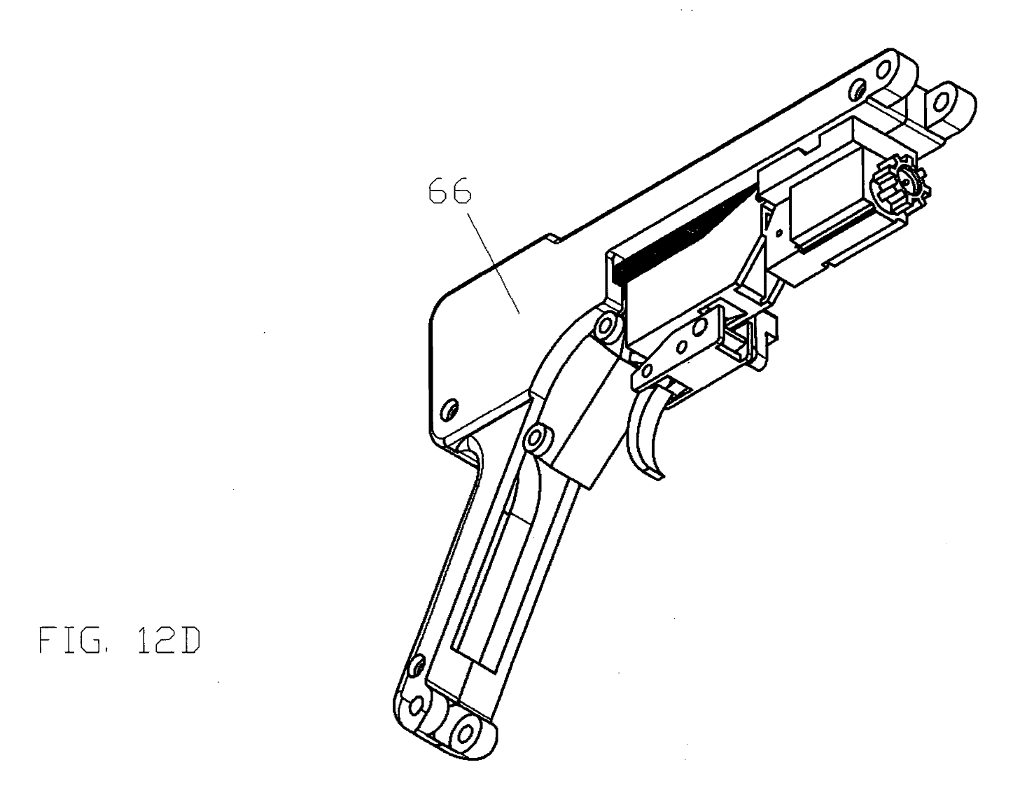

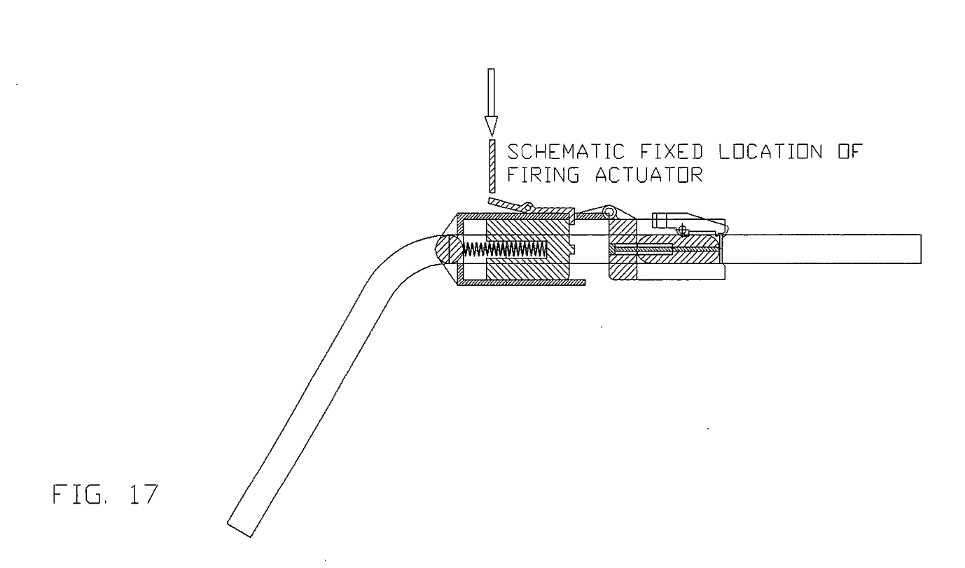

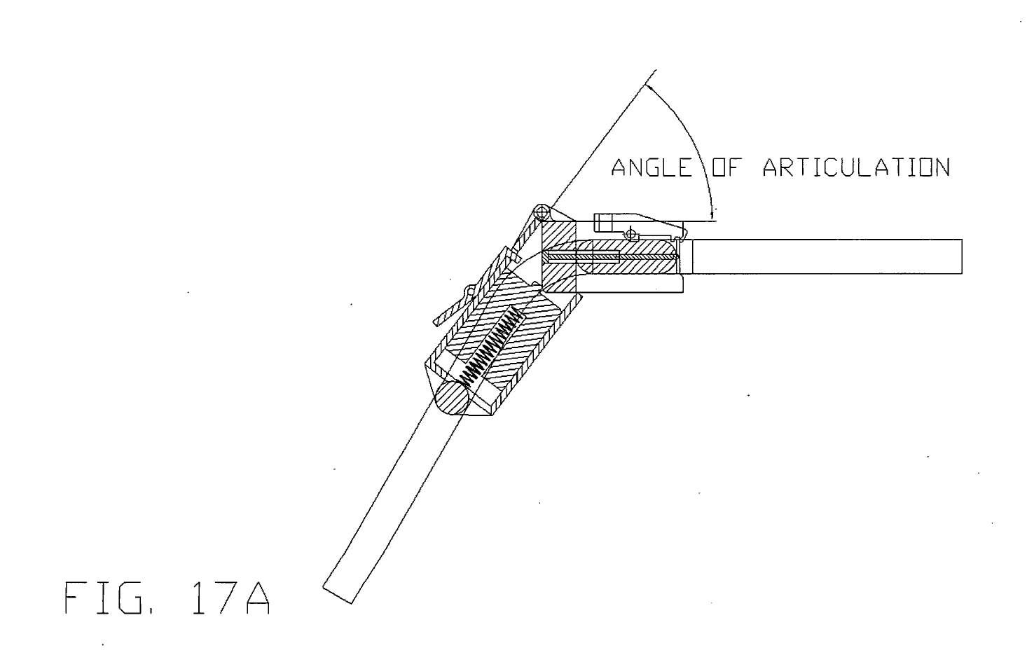

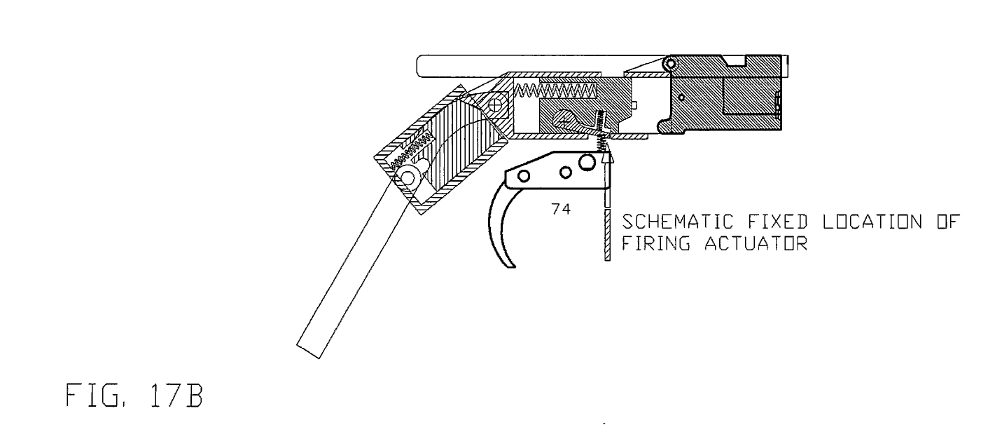

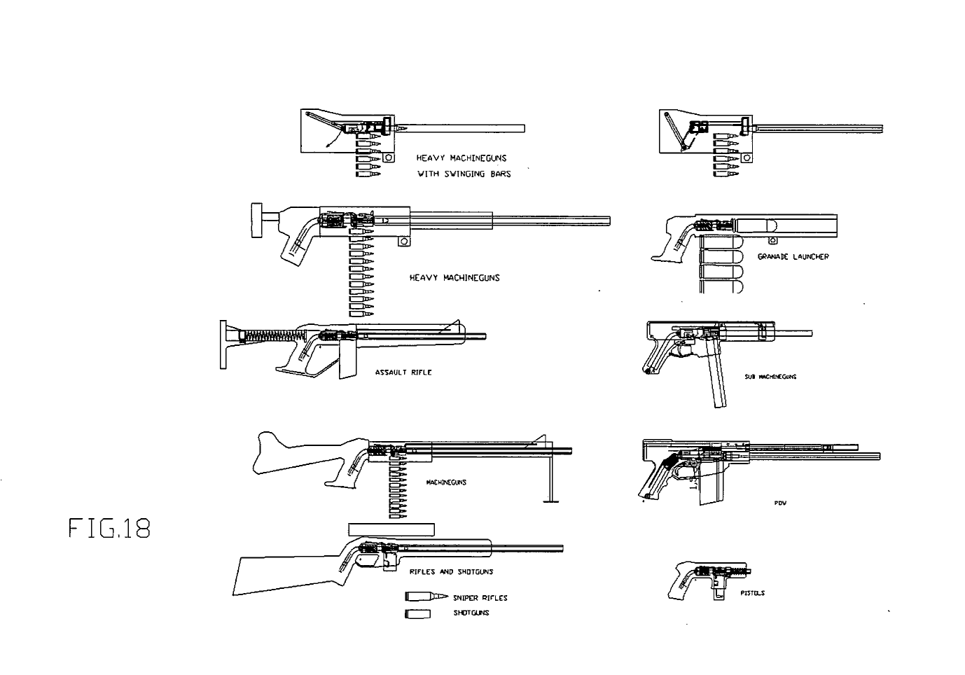

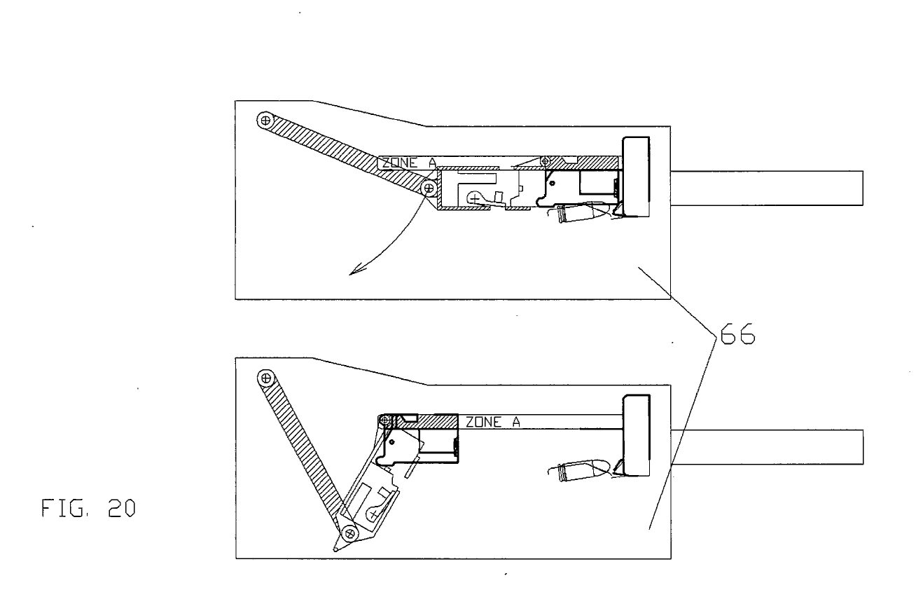

Specially In one embodiment this invention is about a firearm having an Articulated Bolt Train 90 FIG. 9 and FIG. 9A, FIG. 12 TO FIG. 12C and a by design Receiver 66 FIG. 10B, FIG. 11B, FIG. 12B, FIG. 12C that operates in conjunction. In order to function properly, the Bolt Train 90 has to be placed inside a Receiver 66 that controls and governs its path, and holds all the sub assemblies in the convenient location allowing the synchronic movements of all the components to take place. The Receiver 66 FIG. 10A, FIG. 20 can have different shapes, dimensions, and proportions to be used in several applications as shown in FIG. 18.

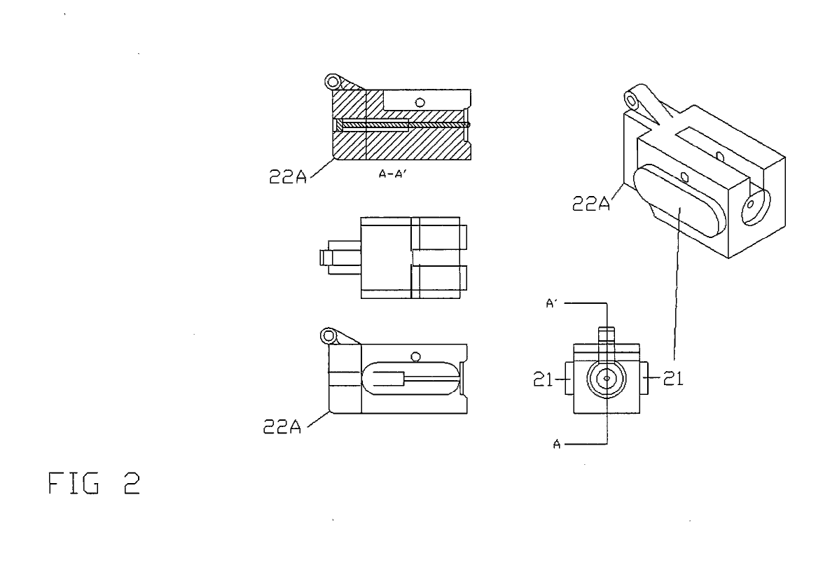

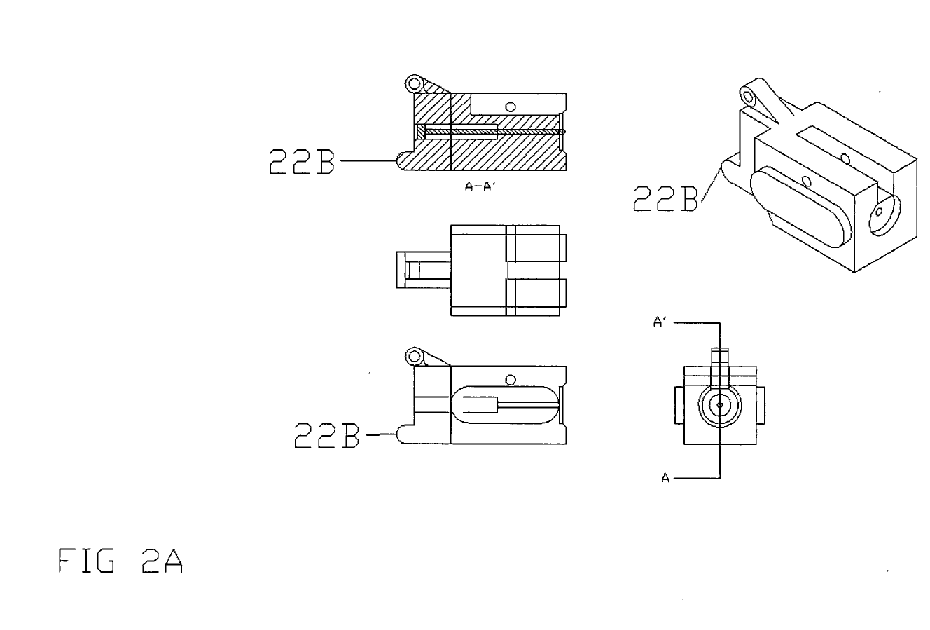

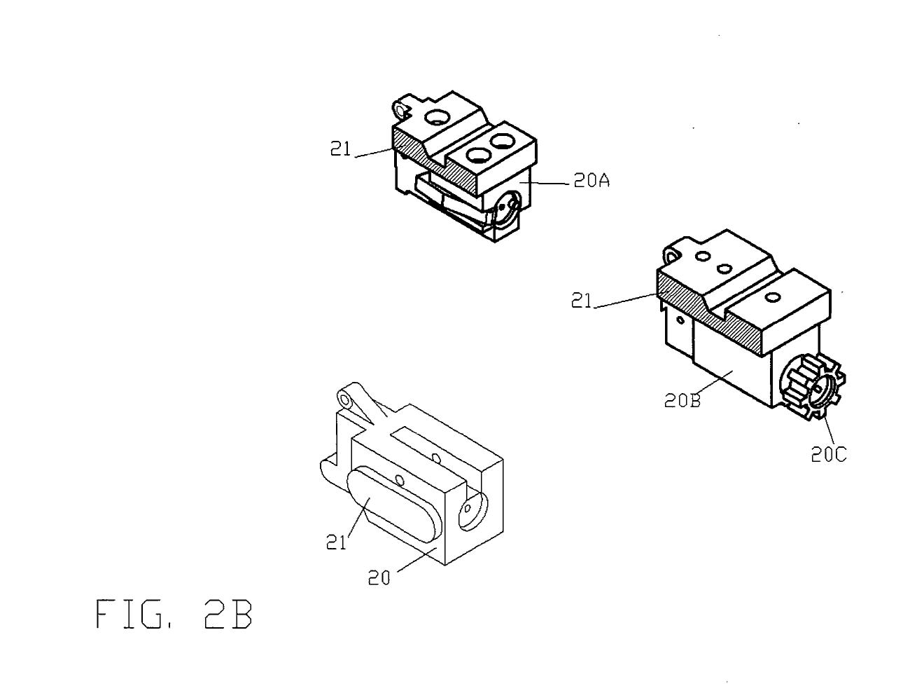

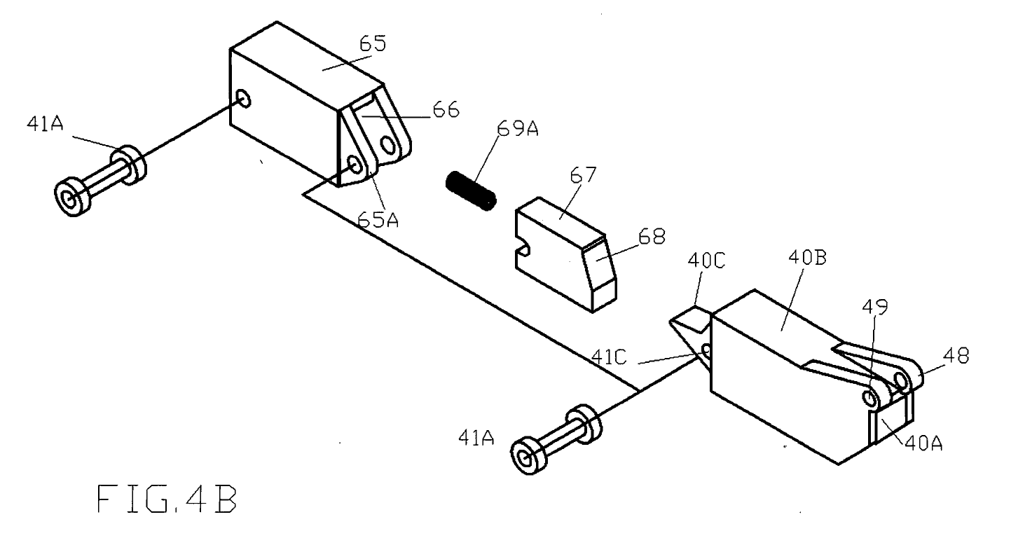

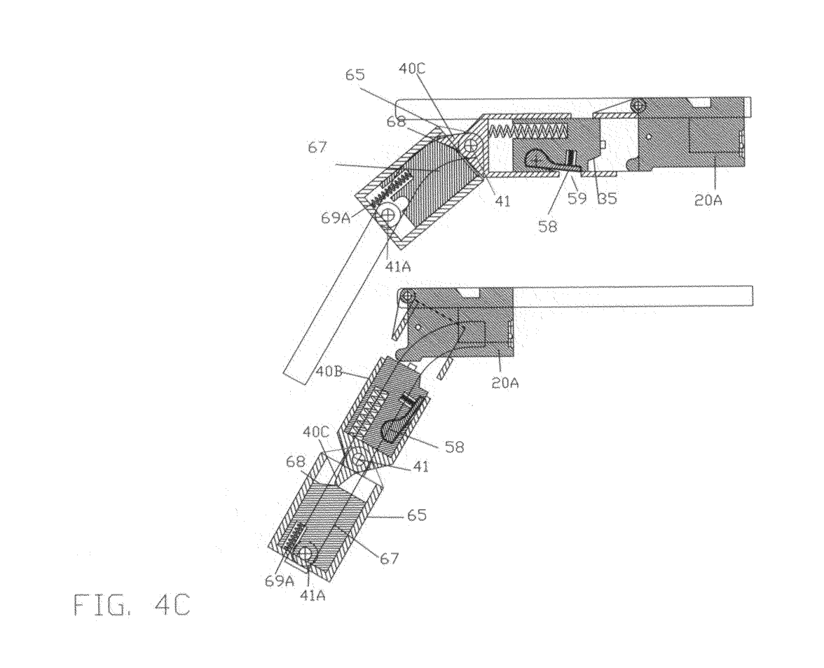

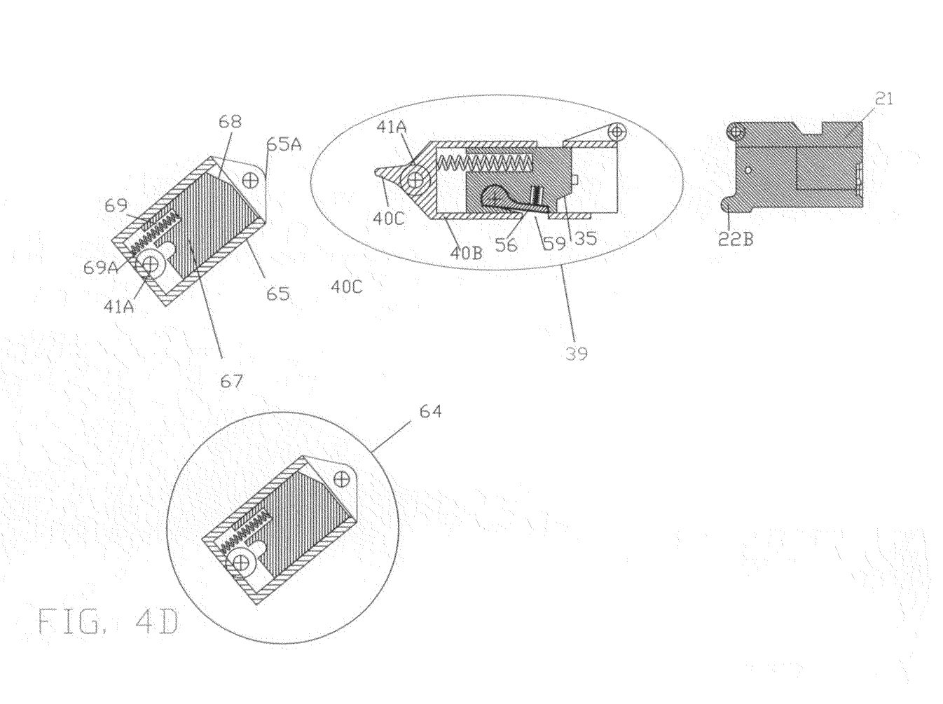

The Articulated Bolt Train 90 consists of a Front Bolt of either Types 20, 20A or 20B, as shown in FIG. 2B, initially moving along the bore axis, articulately linked at the rear to a Mechanism Carriage Housing 40 types 40 or 40B as shown in FIG. 4, FIG. 4A, FIG. 4B, containing The Active Firing Mechanisms. The Mechanism Carriage Housing 40 displaces transversally, articulately linked at the rear to another optional carriage displacing transversally also comprising a Recoil Damper Sub Assembly 64 FIG. 4B. The Articulated Train Bolt 90 is track mounted on slot Channel guides 80 FIG. 10A embedded or supported laterally inside the receiver 66, directing a transversal path. In my invention the conventional firing mechanisms assembly is separated physically in two different groups. The Active Firing Mechanisms subassembly 39 FIG. 5B comprise the hammer, the hammer spring, the sear, sear lever; all of them placed inside a moveable mechanisms carriage housing 40 and are an integral part of the Bolt Train 90. The controlling firing mechanisms subassembly 74 FIG. 5B, FIG. 5C comprise the trigger 75, the lever 76, the safe 77, the column spring fire actuator, and disengager 78 which are housed in a stationary compact small frame 79 in a convenient fixed location. The Fire Actuator and Disengager or disconnector 78A can be of a solid piece sustained by a convenient spring mounted support, enabling its deflection, after being pushed aside by the sear protrusion portion on the forward displacement after firing. Part 78, or alternatively part 78A, have al dual function: pushing the sear out of the engaging surface with the Mechanism Carriage Housing 40, and serving as disconnector for the semiautomatic firing mode.

The Active Firing Mechanisms subassembly 39 compact mechanism array integrates its mass and its volume to the Bolt Train 90 and significantly reduces the number of parts, volume, weight, and lowers the center of gravity, resulting in an effective recoil management absorbing system for automatic or semiautomatic firearms.

2. Background Prior Art

Previously, in firearms, the use of articulated or toggled bolts and connecting masses to control recoil is very old. When recoiling, these types of mechanisms displace in a different direction of the barrel axis creating force vectors partially diverting the initial recoil force, away from the bore axis. The use of this principle is present in the first known auto loading pistol invented by Hugo Borchardt in the C-93 pistol (1893), and the same principle for displacing the bolt rearwards and the heavy connecting bars transversally to reduce the axial recoil is used by Georg Luger in (1898) in the well known P-08 model. Both, Borchardt and Luger, were following the even earlier design of Hiram Maxim incorporating the toggle lock or knee principle. Borchardt and Luger had an exterior articulating bolt fixedly hinged at the rear, but never before a completely movable Interior Articulated Bolt Train.

Several firearms recoil absorbing systems have been patented recently using similar principles that cause an inertia mass to move downwards or transversally by using the original recoil force, transforming it into two force vectors; Like patent U.S. Pat. No. 7,201,094 of Jan Henrik Jebsen. However, none of the previous patents uses the active firing mechanisms as part of the moving recoiling mass displacing transversally. Nor it uses an active recoil damper mechanism. It only moves inertia dead mass downwards.

In previous inventions like patent U.S. Pat. No. 7,201,094 the firearm head bolt is attached to an independent body or mass that contains no mechanisms inside. It is just dead mass. The two bodies are connected by series of linked interconnected parts, some of them requiring sufficient margin of play, like a slotted guide, placed at an inclined angle at the end of one of the bodies. A rod, belonging to the bolt, travels horizontally through a slotted guide. A rod placed transversally becomes the contact point between the bolt and the mass. As the bolt travels horizontally it pushes the rod through the inclined slotted guide causing the effect of a wedge by pushing the mass in a transverse direction. The oblique displacement of the dead inertia mass is forced by a transverse fixed guide bar passing through the mass. However the different means used to achieve the recoil absorption are significantly inefficient in terms of the volume and total weight required. None of the design solutions involve the use of firing mechanisms displacement or the use of the firing mechanisms mass as a part of the recoiling inertial mass. U.S. Pat. No. 7,201,094 of Jan Henrik Jebsen uses a complete conventional separate stationary fixed firing mechanism assembly, placed conveniently that necessitates significant volume and weight to operate. The latter mentioned patent does not have any sort of internal recoil abatement mechanisms inside the inertia mass as my invention has. It is notorious for being voluminous and unwieldy. It is voluminous with a very little barrel length. With respect to the Delay Blowback breech opening function that my invention has, the U.S. Pat. No. 3.283.345 of Theodor Koch is important to mention because it has been extensively divulged and promoted by its use in the Heckler and Koch G3 rifles and especially in the very well known MP 5 sub machineguns. It causes a delay in the breech opening by means of a complicated mechanism inside the bolt whereby a set of sprig loaded rollers are forced to move along a pair of closing arc circle surfaces generating a retention of the force produced by the increasing gas pressure inside the barrel until the point where it overcomes the force of the rollers mechanism, generating a delay. The use of such mechanism has been successful, but has several disadvantages: it is sensitive to dirt, it requires lubrication, rollers break, springs fatigue, and does not lend to trimming.

Advantages

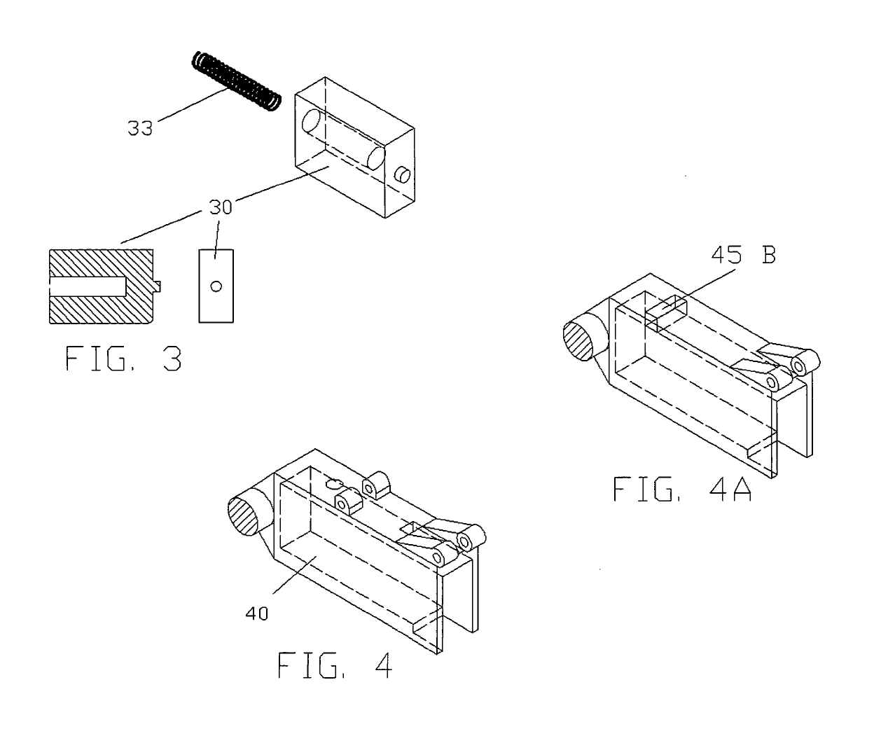

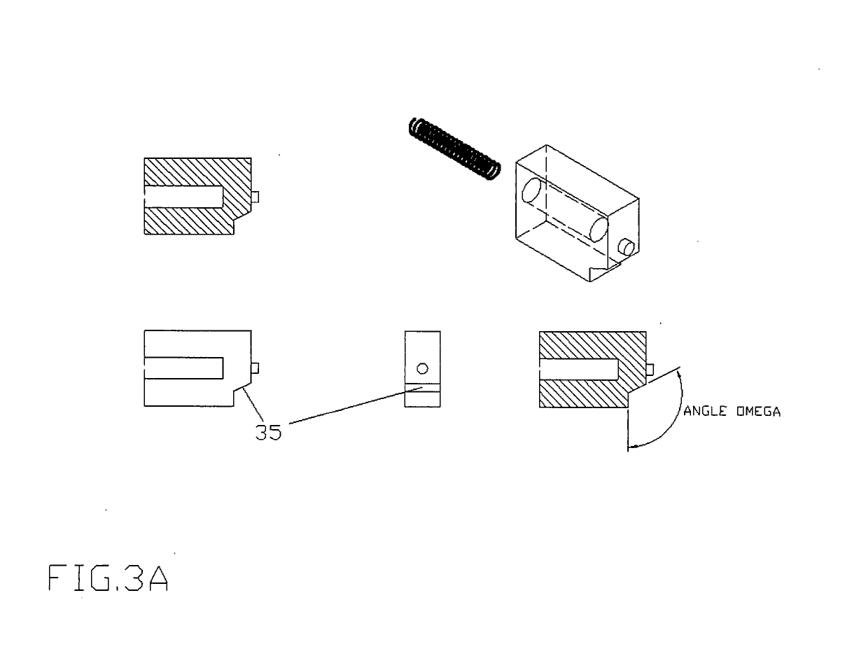

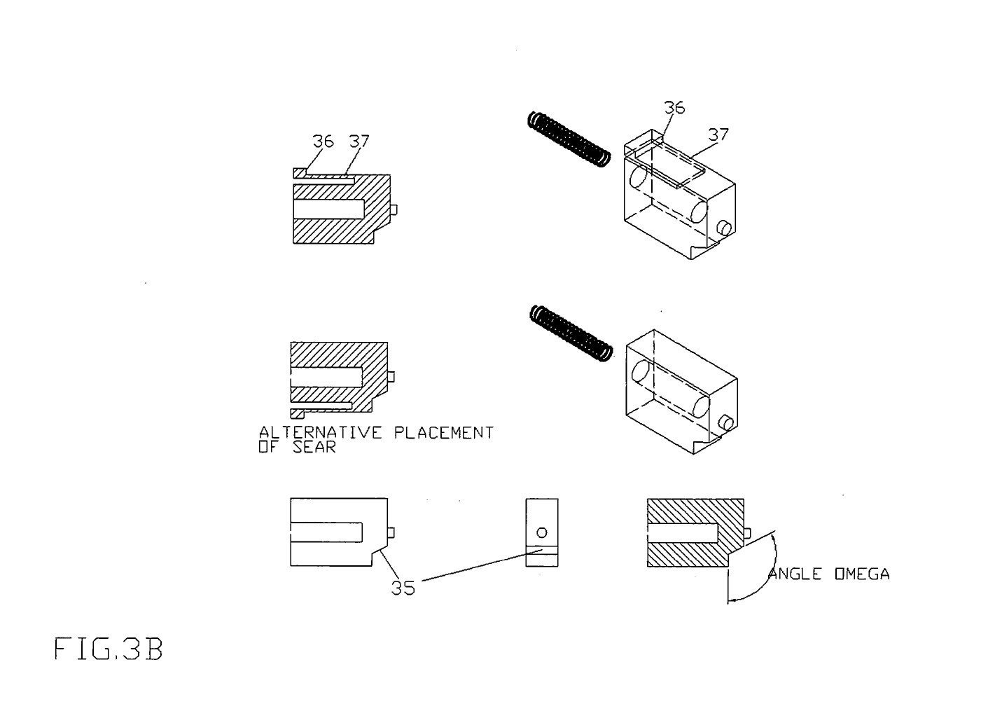

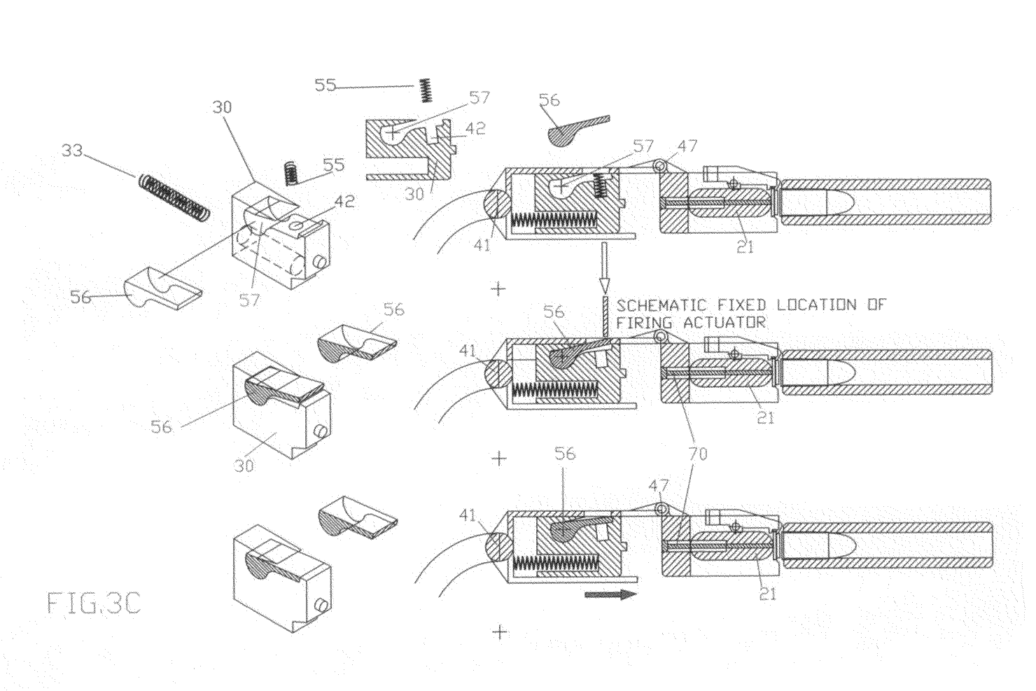

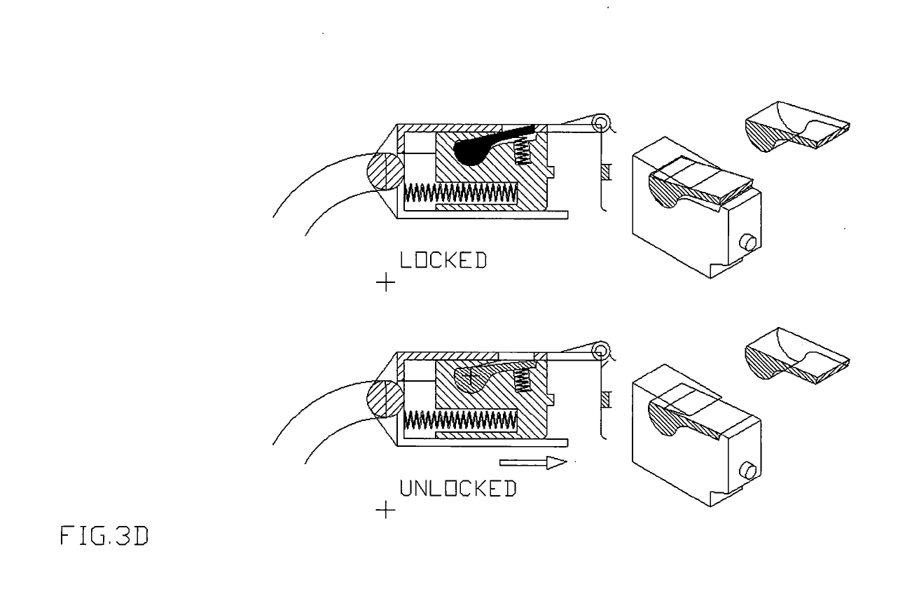

My invention is notoriously different than any other known. The present invention has at least one the following advantages.
My invention integrates the Active Firing Mechanisms as a part of the recoiling Bolt Train and places it for all time in the immediate proximity to the firing pin.
My invention is better because the firing mechanisms are contained in a compact, volume-efficient, carriage that moves transversally.
My invention is better because, when shooting, the firing mechanisms contained in a compact, volume-efficient, carriage moves downwards, through the handle or grip, producing a unique reaction movement of the receiver resulting in a balanced dynamic behavior.
Conventionally, the firing mechanisms and its frame are placed in a fixed dedicated location. My invention makes the firing mechanism movable and uses its mass as part of the Bolt Train 90 mass needed to absorb the recoil, saving volume, weight and lowering the center of gravity.
The active firing mechanisms operate linearly without rotating parts, which make it simple to manufacture and volume effective.
The Controlling Firing Mechanisms subassembly 74 FIG. 5D is modular, easy to change if needed.
A part, the mechanisms carriage housing, has multiple functions. It frames the firing mechanisms, it guides the recoil travel, and it displaces transversally with the contained independent mechanisms in place. At the rear it may have a protruding cam that slides over the inclined plane face of the spring loaded, movable recoil compensator forcing it back, adding additional restrain to the opening of the breech. All that in a very dense compact package, making it efficient in terms of minimal volume.
The mechanisms carriage housing has a rear protruding cam that works in conjunction with the recoil damper sub assembly to produce additional restriction to the rearwards motion, adding more delay to the breech opening.
When the firing mechanisms sub assembly works in conjunction with the protruding delay cam of the Front Bolt 20, it creates a delay on the blowback opening motion without requiring any additional moving parts.
The mechanisms carriage housing and mechanism can slide down through the firearm handgrip, making it very compact and volume efficient.
The proximity of the compact Bolt Train to the top of the shooter' grabbing first lowers the center of gravity of the weapon creating a better handling.
When the mechanisms carriage housing and mechanism slide down through the firearm handgrip, the effect of the downwards displacement is felt directly on the grip, eliminating any moments about the grabbing point.
This novel mechanism can be used in many types of firearms; pistols; rifles, shotguns; machineguns; sub-machineguns; heavy machineguns; sniper rifles, grenade launchers, heavy weapons all the above semi automatic and full automatic, gas operated, long or short stroke, blowback, delayed blowback recoil, with rotary bolts and bolt carrier, electrical or mechanical firing.
These mechanisms can be used in bullpup configuration.
The front bolt can be used as a bolt carrier, enabling the use of rotary locking bolts.
The bolt carrier can be used in conjunction with direct drive rods with gas operated bolts.
Firearms using this type of bolt lend to be manufactured with polymer injected materials, which translates into low production costs.
The progressive displacement downwards of the mechanisms carriage housing and mechanism provides a smooth transition of the reaction force.
Rollers can be added to the guide rods to smooth the operation.
Rollers can be adder to the hammer to smooth the operation.
My design is better because it uses the change of direction of the path of the bolt train to cock the firing mechanisms.
My design is better and novel because it incorporates a delay blowback breech opening mechanism in the rearwards recoil motion, which enhances the delivered energy of the projectile, and reduces the pressure at the breech when opening.
The delay blowback breech opening system of my invention achieves the same results of Koch with a very simple interaction of two parts and lends to be trimmed by producing a desired controlling surface in the front face of the slider striking hammer.
The delay opening mechanism slows the rate of fire when used in full automatic mode.
This invention is far simpler and advantageous than the one of Jebsen because it only uses only one displaced articulation or hinge as the means of linkage between the front bolt and the mechanisms carriage housing. The movement required at the articulation is only rotational.
No margin of play is required between the front bolt and the mechanisms carriage housing.
My invention does not require any mobile breech to interlock the front bolt and the mechanisms carriage housing.
FIG. 18 shows the schematics of numerous applications where my invention could be used advantageously.
My invention requires a smaller number of components in comparison to any other gun.
My invention has a moving cylindrical extruded sear 58 inside the hammer integrated to the Firing mechanism sub assembly.
Alternatively, my invention comprises a self sprigged sear-hammer FIG. 3B.
When required, internal sears can be used to protrude laterally to outside of the Mechanism Carrier Housing 40 and 40B, and engage against it, to become operational with side mounted column spring or pushing bar 78A FIG. 5D of the controlling firing mechanisms.
The Bolt Train 90 can be used in conjunction of Gas piston systems
The bolt train 90 can be used in conjunction with rotary bolts.
When additional kinetic energy absorption is desired a third component to the Bolt Train 90 can be attached: the Recoil Damper Subassembly FIG. 4B and FIG. 4C.
By the Precession generated by the partial rotation motion of the Articulated Bolt Train 90, while shifting from the bore axial path to the transverse path, this mechanism is capable of compensating to some extent, the rotation reaction (Barrel Torque) of the barrel and parts attached to it (gun), that occurs when the rotational reaction is impaired to the projectile whilst being propelled through the rifled barrel,

### SUMMARY

In accordance with one embodiment, this invention generally relates to a firearm having a collection of mechanisms and arrays, conceived to manage recoil by changing the dynamic behavior of the weapon when firing, in a manner that redirects forces, creates delays, decelerates motion, and lowers significantly the center of gravity, resulting in an improvement of the handling of the gun.

A firearm comprising several modular subassemblies, a Barrel, a receiver, an Articulated Bolt Train that alternates between a forward and backward position, an active firing mechanism, a delay blowback method, a controlling firing mechanism, a set of recovery springs, a set off modular multifunctional supports, a buffer mechanism, a Modular Cocking Handle mechanism, a direct drive gas system. The alternate transversal displacement of the Articulated Bolt Train, and the intrinsic delay designs, conveys to the firearm a unique dynamic behavior resulting in smooth recoil. Many variables in the displacement of the Articulated Bolt Train constitute a formidable opportunity for engineers to trim the design for each specific case of application.

### DRAWINGS PARTS REFERENCE NUMBERS

DRAWINGS - REFERENCE NUMERALS

| PART | |
|---|---|
| NUMBER | PART NAME |
| 20 | BOLT |
| 21 | HORIZONTAL PROTRUDING GUIDE (2) |
| 22 | REAR RECTANGULAR PROTRUSION |
| 22A | EDGE LINE |
| 22B | PROTRUDING DELAY OPENING CAM |
| 23 | CYLINDRICAL DELAY OPENING CAM |
| 24 | TOP HINGE |
| 25 | HOLE FOR PIN |
| 26 | RECTANGULAR SLOT FOR EXTRACTOR |
| 27 | FRONTAL FACE |
| 28 | CYLINDRICAL UNDERCUT FOR CARTRIDGE |
| | REAR FACE |
| 29 | FRONTAL HOLE FOR FIRING PIN |
| 30 | STRIKER HAMMER |
| 31 | CYLINDRICAL CAVITY FOR SPRING |
| 32 | PUSH ROD FOR FIRING PIN |
| 33 | STRIKER HAMMER SPRING |
| 34 | FRONT FACE OF HAMMER |
| 35 | DELAY OPENING SLOPED FACE |
| 36 | SEAR ANGULAR FACE |
| 37 | SEAR FLAT SPRING |
| 38 | |
| 39 | FIRING MECHANISM SUBASSEMBLY |
| 40 | MECHANISM CARRIER HOUSING |
| 40A | RECTANGULAR CAVITY |
| 41 | ROD GUIDE ROLLER GUIDE AND HINGE PIN |
| 42 | CYLINDRICAL HOLE FOR SEAR SPRING |
| 43 | HINGES FOR SEAR LEVER |
| 44 | HOLES FOR PIN |
| 45 | SQUARE HOLE FOR SEAR TIP |
| 46 | PIN FOR SEAR LEVER |
| 47 | PIN FOR BOLT HINGE, AND MECHANISM CARRIER |
| | HOUSING HINGE |
| 48 | MECHANISM CARRIER HOUSING HINGE |
| 49 | HOLE FOR MECHANISM CARRIER HOUSING |
| | HINGE PIN |
| 50 | SEAR LEVER |
| 51 | SEAR LEVER HINGE |
| 52 | HOLE FOR SEAR LEVER HINGE PIN |
| 53 | SEAR LEVER SPRING |
| 54 | ANGULAR FACE TIP |
| 55 | TOGGLE INTERNAL SEAR SPRING |
| 56 | TOGGLE INTERNAL SEAR |
| 57 | SEAR CAVITY |
| 58 | EXTRUDED SEAR |
| 59 | WINDOW HOLE |
| 60 | EXTRACTOR |
| 61 | EXTRACTOR PIN |
| 62 | EXTRACTOR SPRING |
| 63 | EXTRACTOR HOLE |
| 64 | |
| 65 | |
| 66 | RECEIVER |
| 67 | |
| 68 | |
| 69 | |
| 70 | FIRING PIN |
| 71 | FIRING PIN REAR |
| 72 | FIRING SPRING |
| 73 | FRONT END OF FIRING PIN |
| 74 | CONTROLLING FIRING MECHANISM SUBASSEMBLY |
| 75 | TRIGGER |
| 76 | LEVER |
| 77 | SAFETY CAM |
| 78 | COLUMN SPRING OR PUSHING BAR |
| 78A | LATERAL PUSHING BAR |
| 79 | FIRING MECHANISM FRAME |
| 80 | SLOT CHANNEL GUIDE |
| 90 | BOLT TRAIN |

### FIGURE REFERENCE NUMERALS

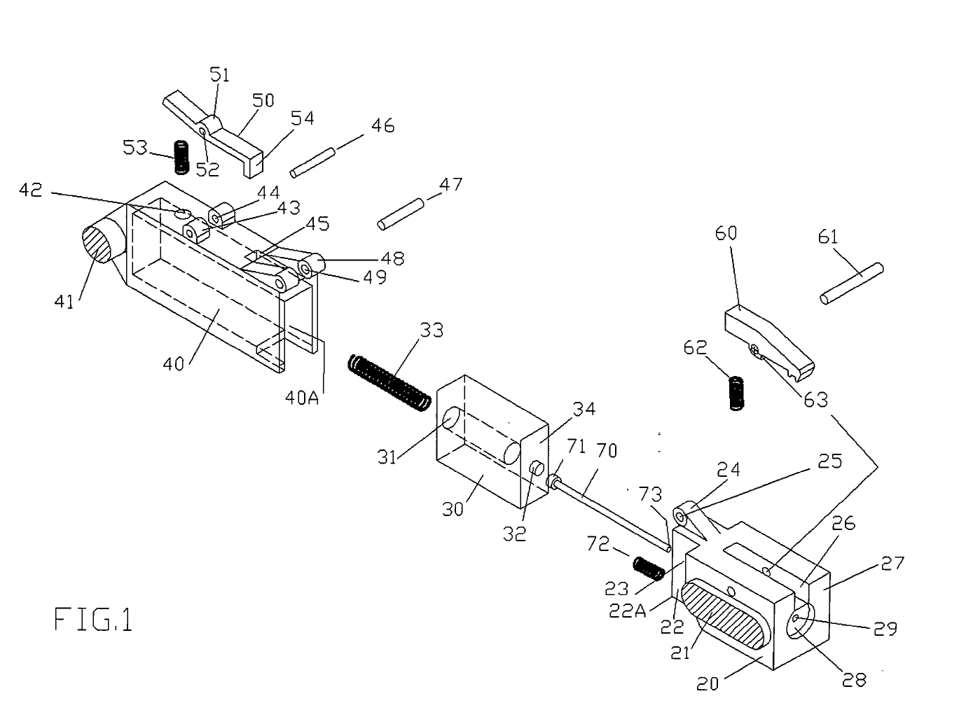

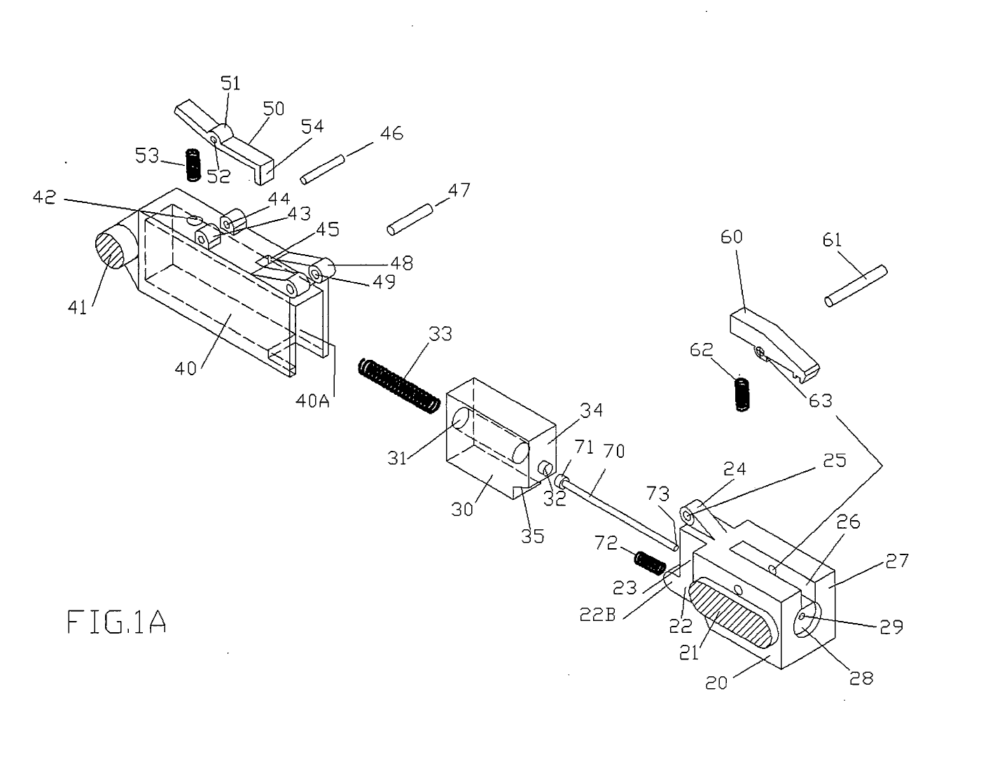

FIG. 1 GENERAL ASSEMBLY

FIG. 1A GENERAL ASSEMBLY WITH DELAY OPENING

FIG. 2 FRONT BOLT

FIG. 2A FRONT BOLT WITH DELAY OPENING CAM

FIG. 2B SEVERAL FRONT BOLT CONFIGURATIONS

FIG. 3 HAMMER

FIG. 3A HAMMER WITH DELAY OPENING SLOPPED FACE.

FIG. 3B HAMMER WITH SEAR AND SPRING

FIG. 3C HAMMER WITH INTERNAL ROTARY SEAR AND SPRING i

FIG. 3D INTERNAL ROTARY SEAR LOCKING DETAIL

FIG. 4 MECHANISM CARRIER HOUSING

FIG. 4A MECHANISM CARRIER HOUSING FOR HAMMER WITH SEAR

FIG. 4B RECOIL DAMPER SUBASSEMBLY AND FIRING MECHANISM CARRIER HOUSING

FIG. 4C CUT VIEW OF BOLT TRAIN WITH A THIRD MEMBER DELAY DAMPER

FIG. 4D RECOIL DAMPER SUBASSEMBLY AND FIRING MECHANISM SUBASSEMBLY

FIG. 5 EXTERNAL SEAR

FIG. 5A CYLINDRICAL ROD INTERNAL SEAR

FIG. 5B FIRING MECHANISM SUBASSEMBLY AND CARRIER

FIG. 5C CONTROLLING FIRING MECHANISM SUBASSEMBLY

FIE.5D

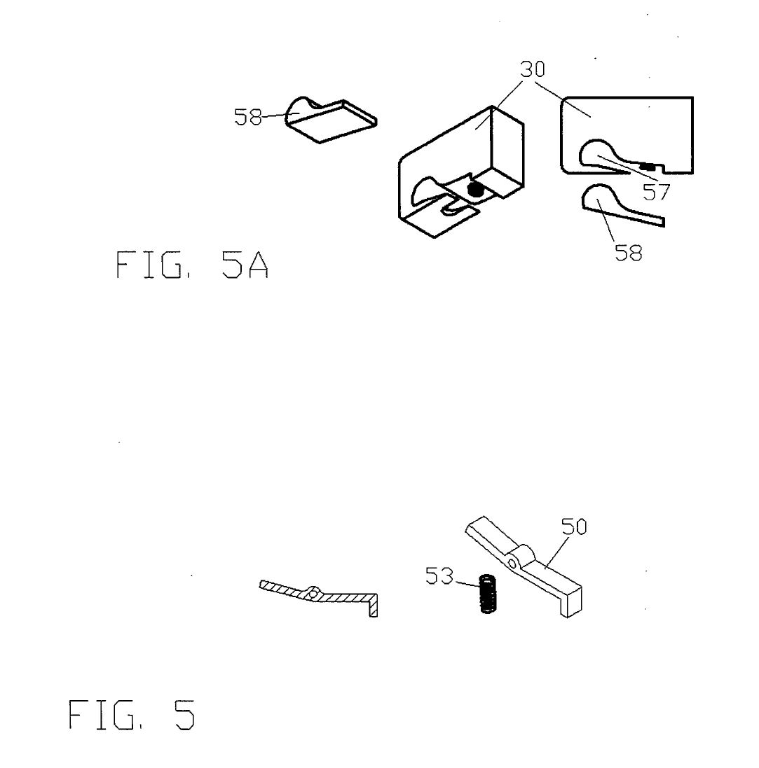

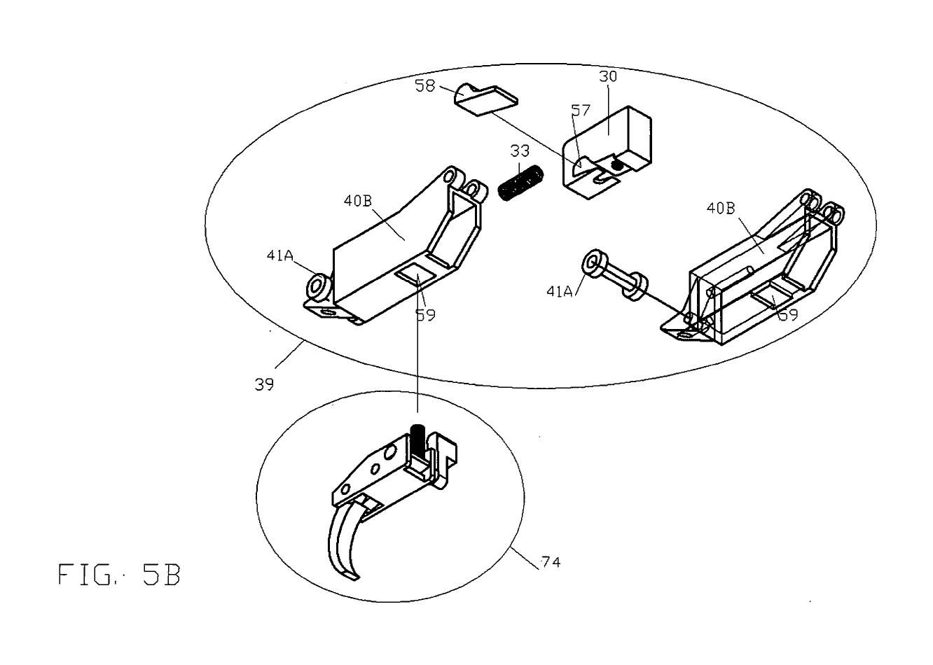

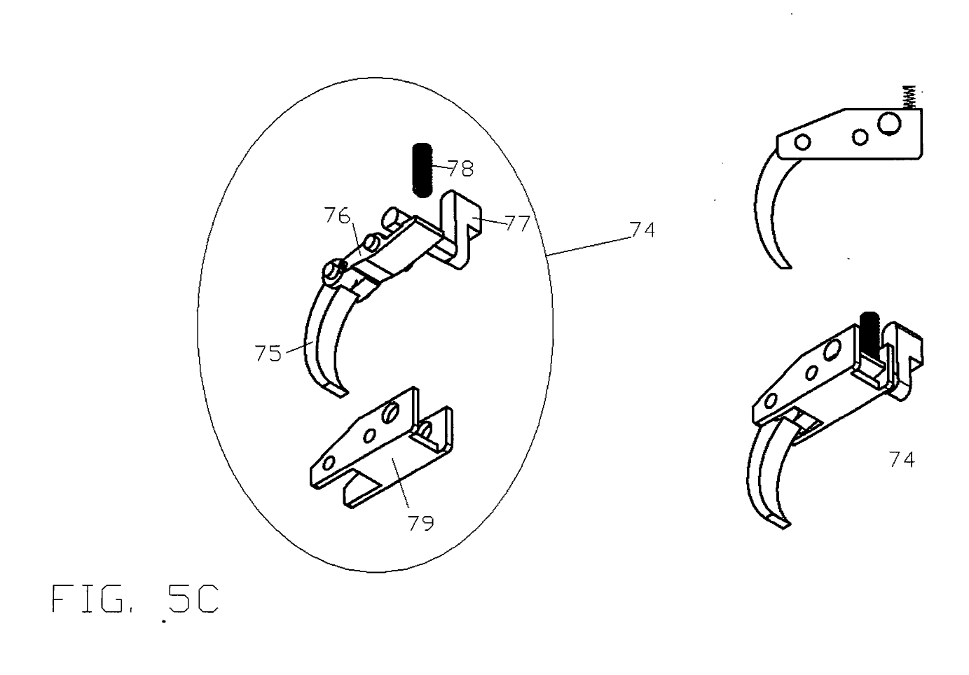

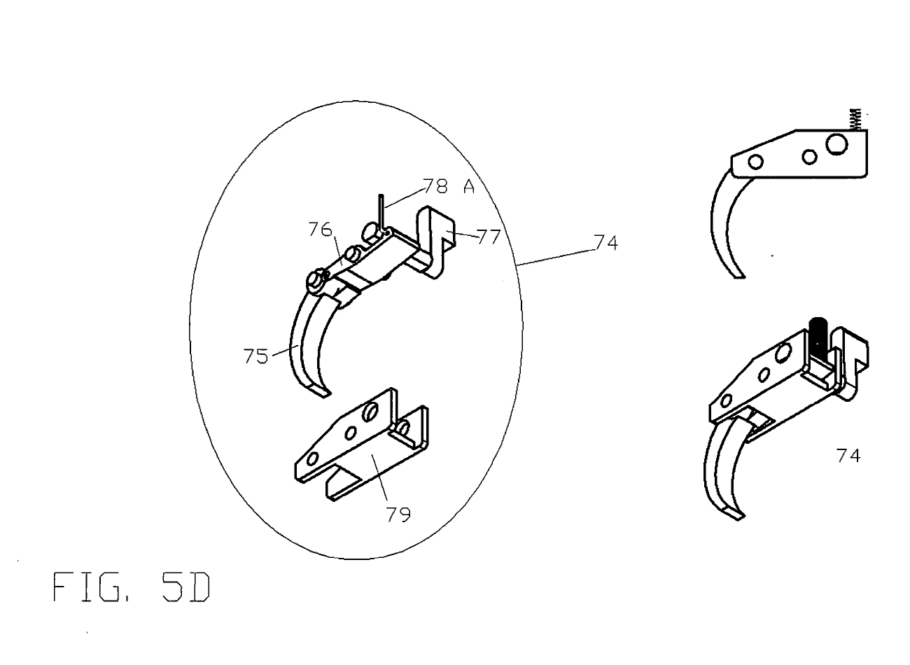

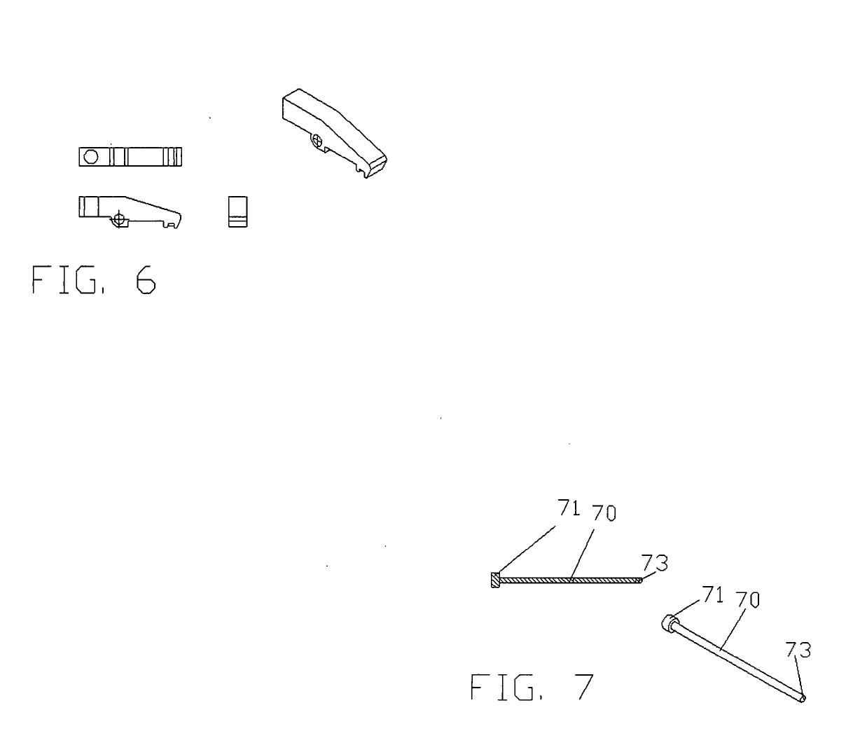

FIG. 6 EXTRACTOR

FIG. 7 FIRING PIN

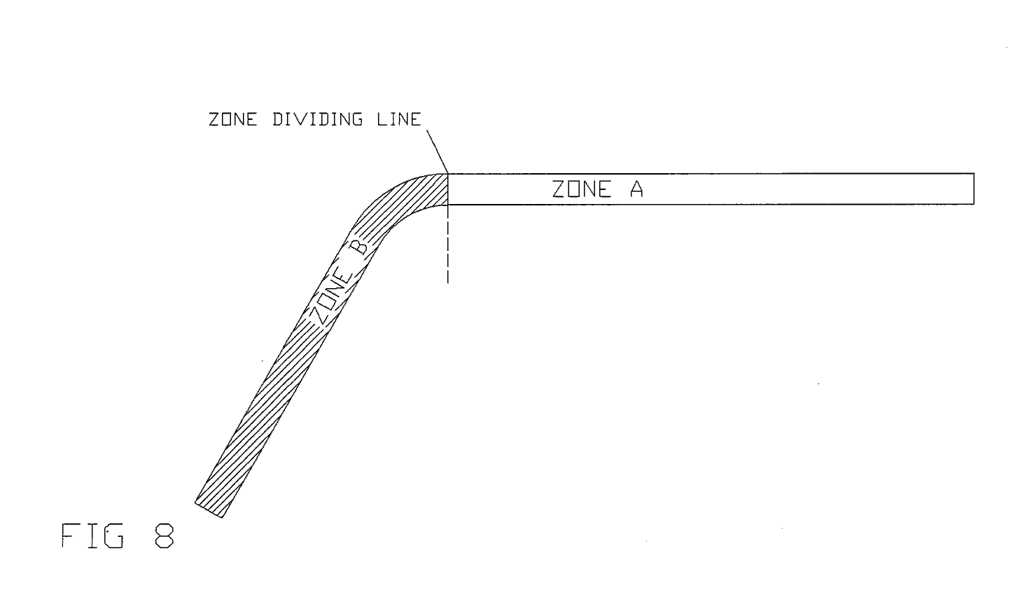

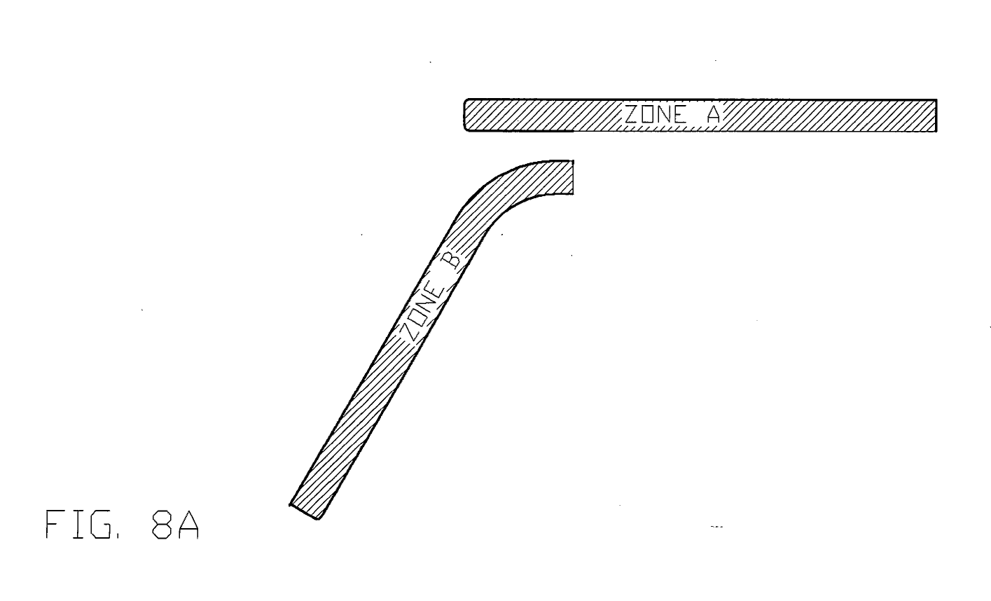

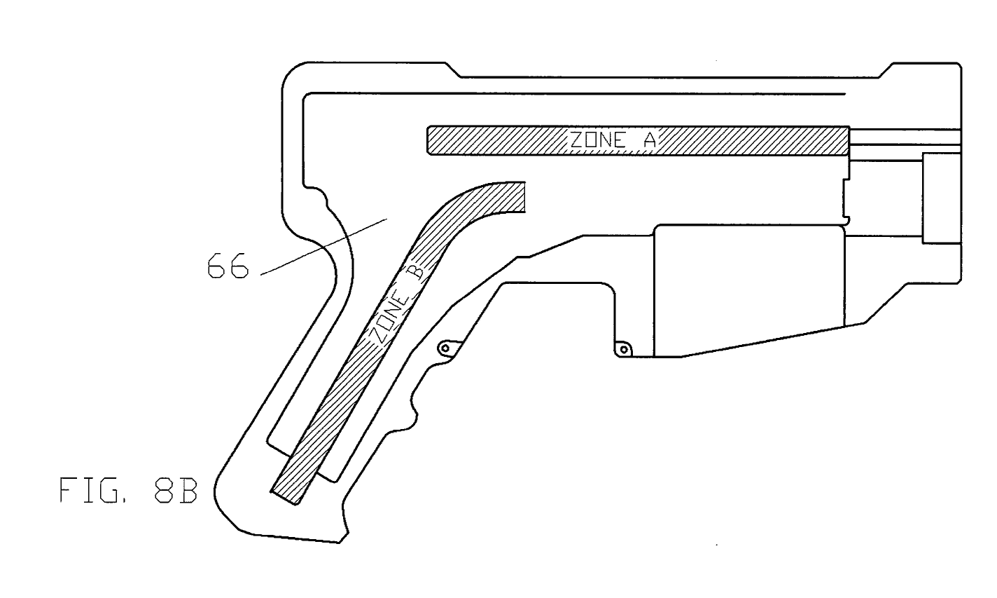

FIG. 8 CONTINUOUS CHANNEL GUIDE (TRACK SEGMENTS ZONE A, ZONE B)

FIG. 8A SEPARATED CHANNEL GUIDES (TRACK SEGMENTS ZONE A, ZONE B)

FIG. 8B POSSIBLE LOCATION OF CHANNEL GUIDES (TRACKS) ON A RECEIVER

FIG. 9 ARTICULATED BOLT TRAIN WITH ASSEMBLED BOLT AND MECHANISM CARRIER

FIG. 9A ARTICULATED BOLT TRAIN WITH TWO OR THREE SUBASSEMBLIES

FIG. 10 PLACEMENT OF ARTICULATED BOLT TRAIN ON A CONTINUOUS CHANNEL TRACK

FIG. 10A PLACEMENT OF ARTICULATED BOLT TRAIN ON A SEPARATED CHANNEL TRACKS

FIG. 10B PLACEMENT OF SEPARATED CHANNEL GUIDES ON A RECEIVER

FIG. 11 PATH OF THE CONTINUOUS GUIDES ON THE CHANNEL TRACK

FIG. 11A PATH OF THE SEPARATE CHANNEL TRACKS

FIG. 11B PATH OF THE SEPARATE CHANNEL TRACK ON A DECEIVER

FIG. 12 BOLT TRAIN IN MOST FORWARD PLACEMENT ON CONTINUOUS CHANNEL TRACKS

FIG. 12A BOLT TRAIN WITH THREE MEMBERS IN MOST FORWARD PLACEMENT ON SEPARATE CHANNEL TRACKS

FIG. 12B BOLT TRAIN IN MOST FORWARD PLACEMENT INSIDE AN ARTICULATED OPEN RECEIVER

FIG. 12C BOLT TRAIN IN MOST FORWARD PLACEMENT INSIDE A CLOSED RECEIVER

FIG. 12D BOLT TRAIN IN MOST FORWARD PLACEMENT RELATIVE TO UPPER RECEIVER

FIG. 12E SIDE VIEW OF THE BOLT TRAIN IN MOST FORWARD PLACEMENT RELATIVE TO UPPER RECEIVER

FIG. 13 CUT VIEW OF A BOLT TRAIN IN FIRING POSITION

FIG. 13A SCHEMATIC DETAIL OF DELAY MECHANISM

FIG. 13B CUT VIEW OF A THREE MEMBER BOLT TRAIN IN FIRING POSITION

FIG. 14 CUT VIEW OF A THREE MEMBER BOLT TRAIN WITH RECOIL DAMPER IN MOST FORWARD POSITION

FIG. 14A CUT VIEW OF A THREE MEMBER BOLT TRAIN WITH RECOIL DAMPER IN MOST REARWARDS POSITION

FIG. 15 CUT VIEW OF A BOLT TRAIN IN FORWARD POSITION WITH EXTERNAL SEAR ENGAGED

FIG. 15A CUT VIEW OF A THREE MEMBER BOLT TRAIN IN FORWARD POSITION WITH INTERNAL SEAR ENGAGED

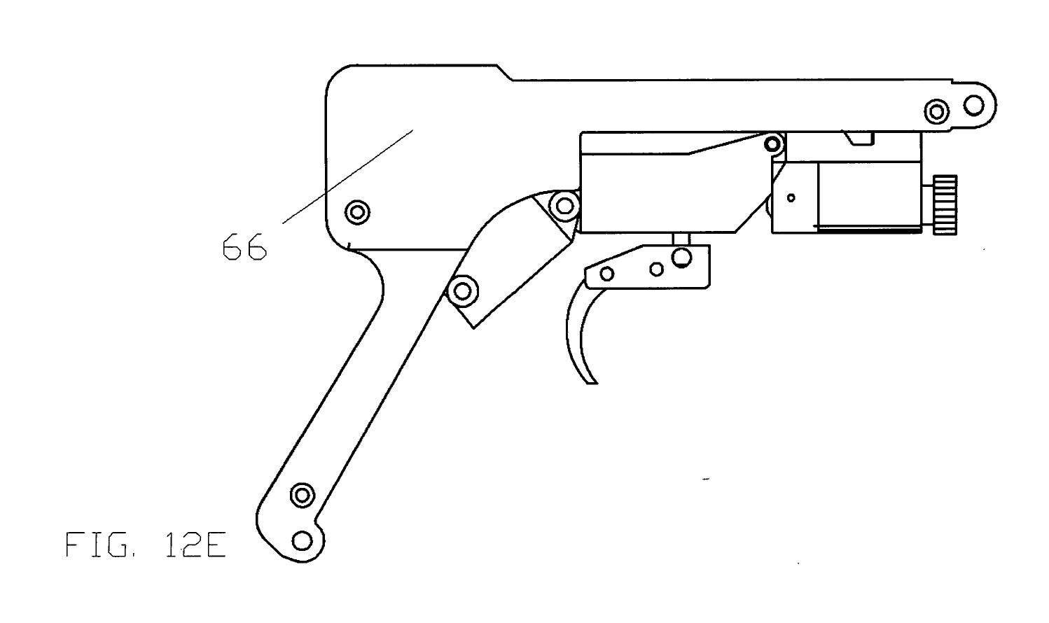

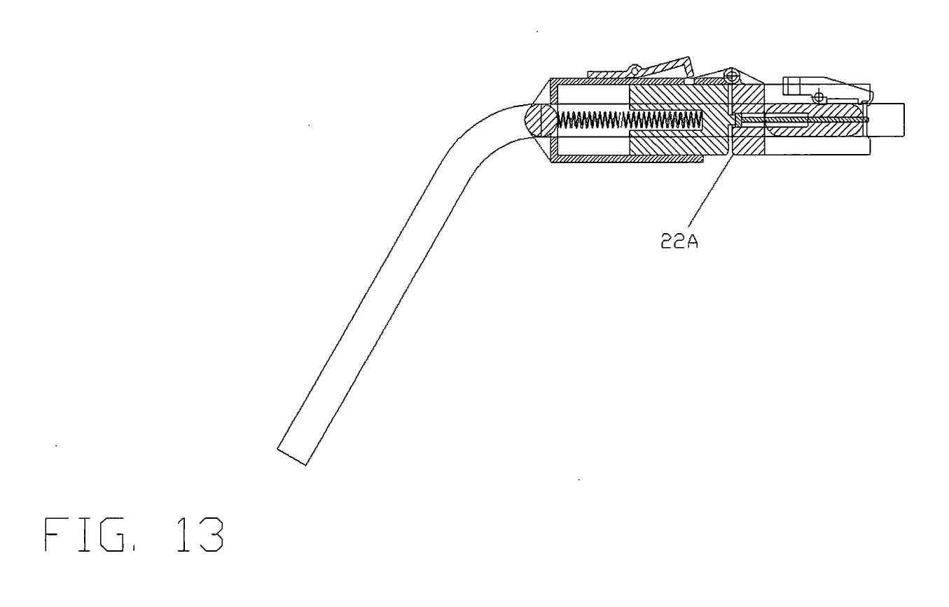

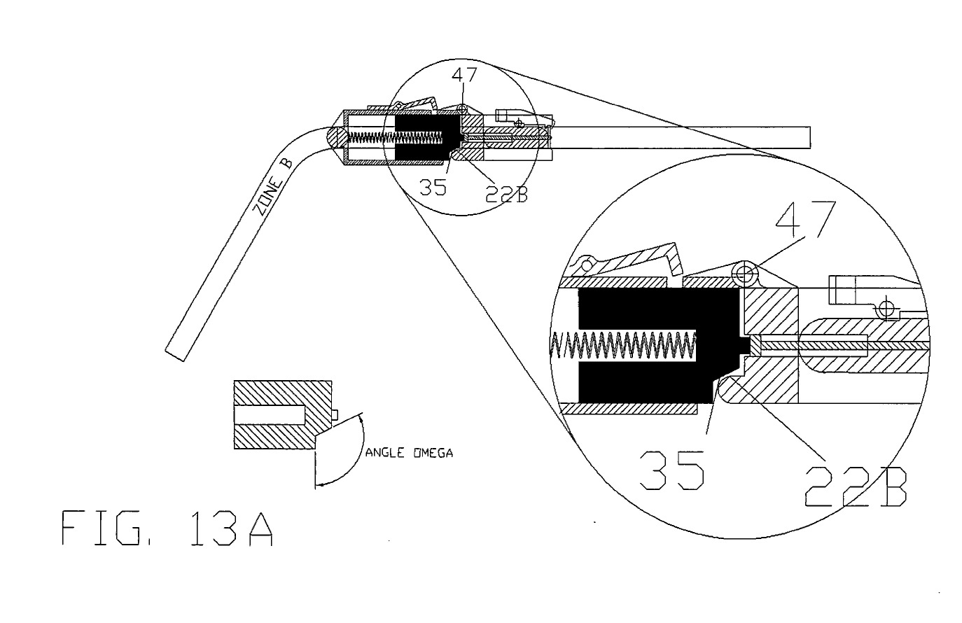

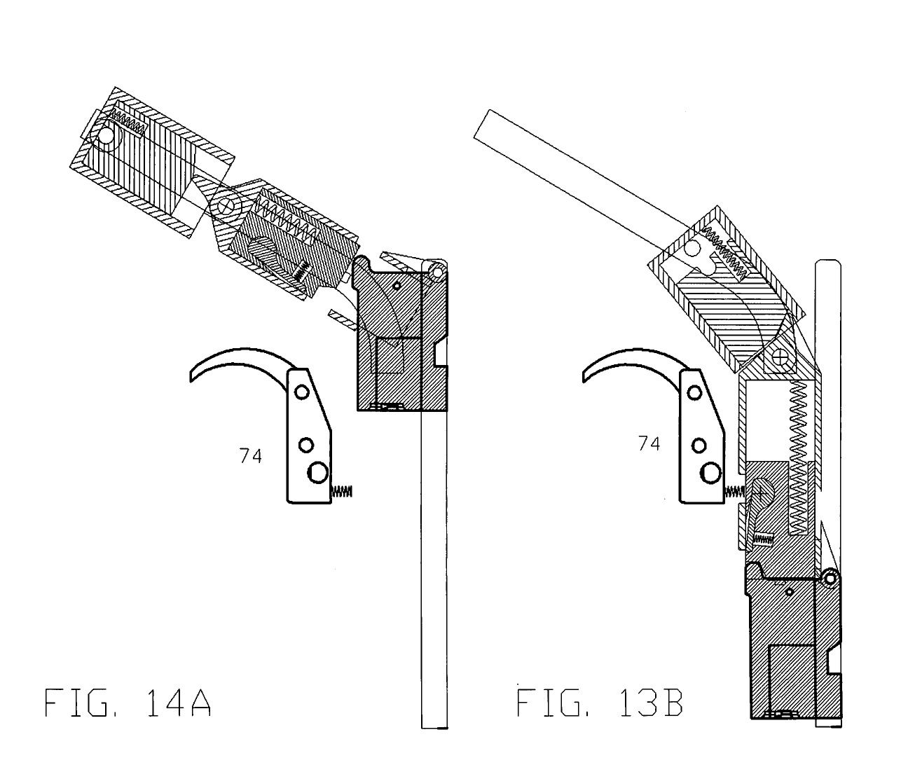

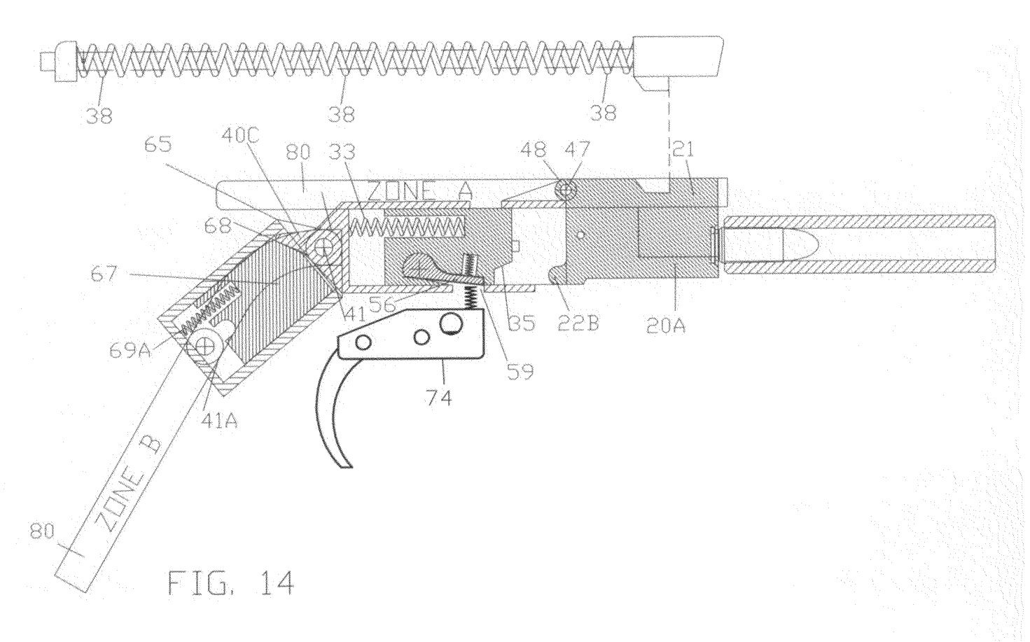

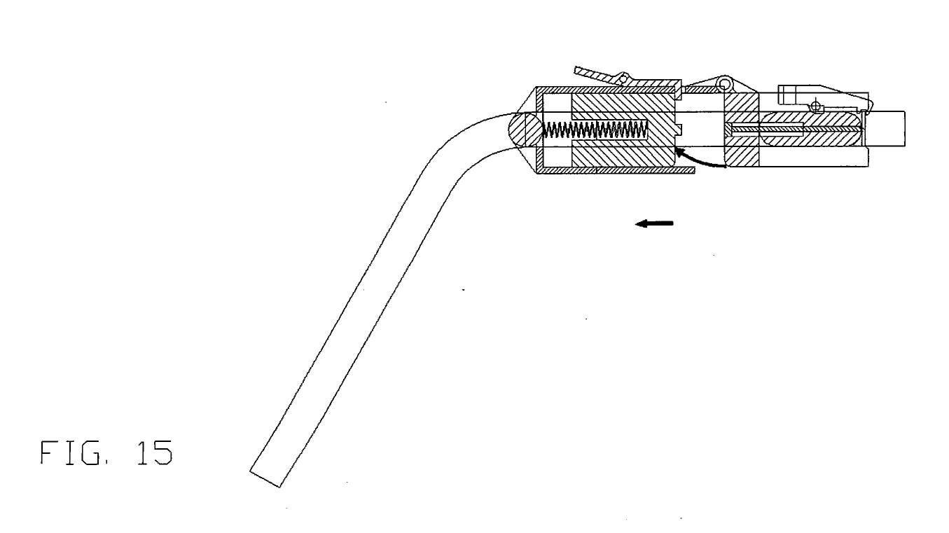

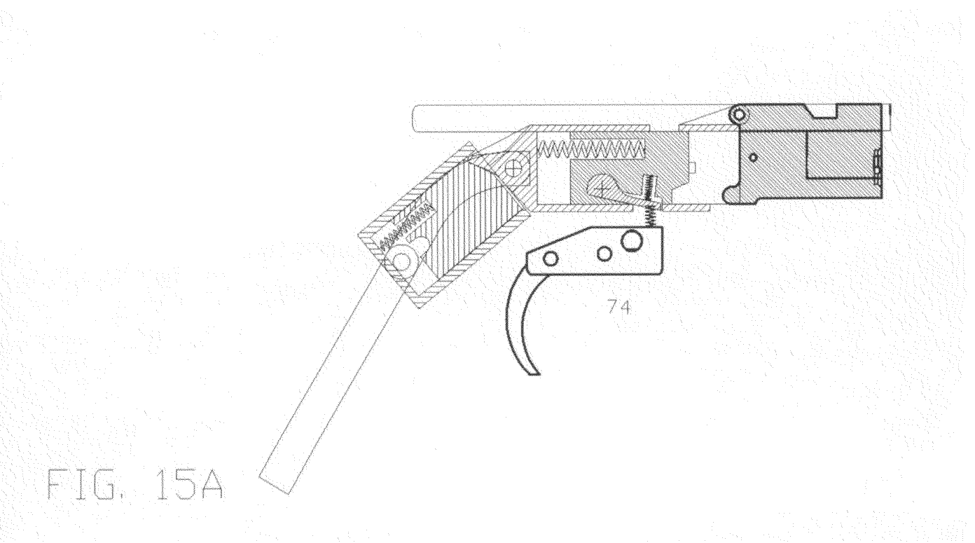

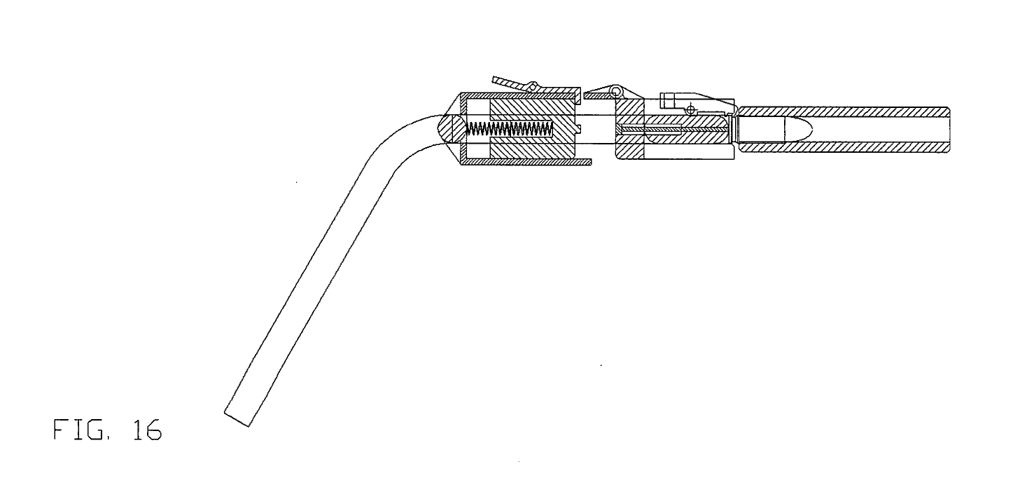

FIG. 16 CUT VIEW OF BOLT AND MECHANISMS READY TO FIRE WITH CARTRIDGE

FIG. 17 SCHEMATIC OF FIRING MECHANISM PLACEMENT ON AN EXTERNAL SEAR

FIG. 17A SCHEMATIC OF ANGLE OF ARTICULATION

FIG. 17B SCHEMATIC OF FIRING MECHANISM PLACEMENT ON AN INTERNAL SEAR

FIG. 18 SCHEMATIC OF POSSIBLE USES OF ARTICULATED BOLT TRAIN MECHANISM

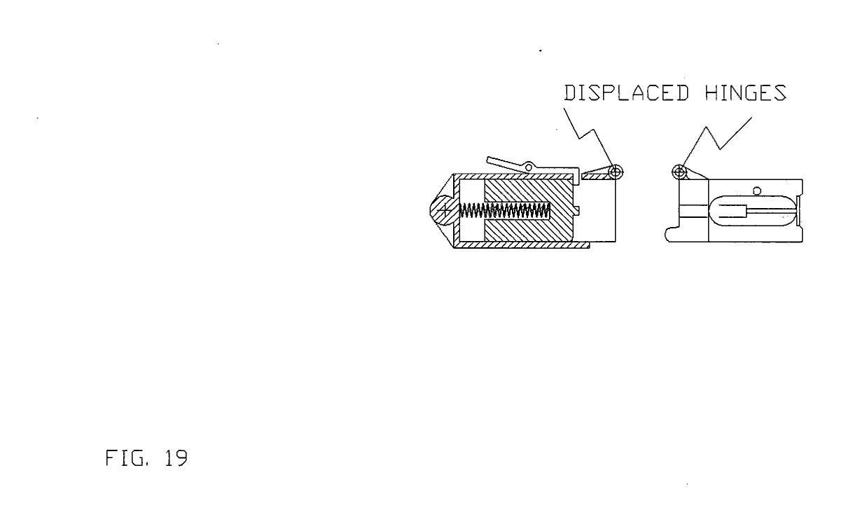

FIG. 19 SCHEMATIC OF LOCATION OF THE DISPLACED HINGES

FIG. 20 ALTERNATIVE METHOD OF DISPLACEMENT OF THE BOLT TRAIN SUBASSEMBLY BY BARS

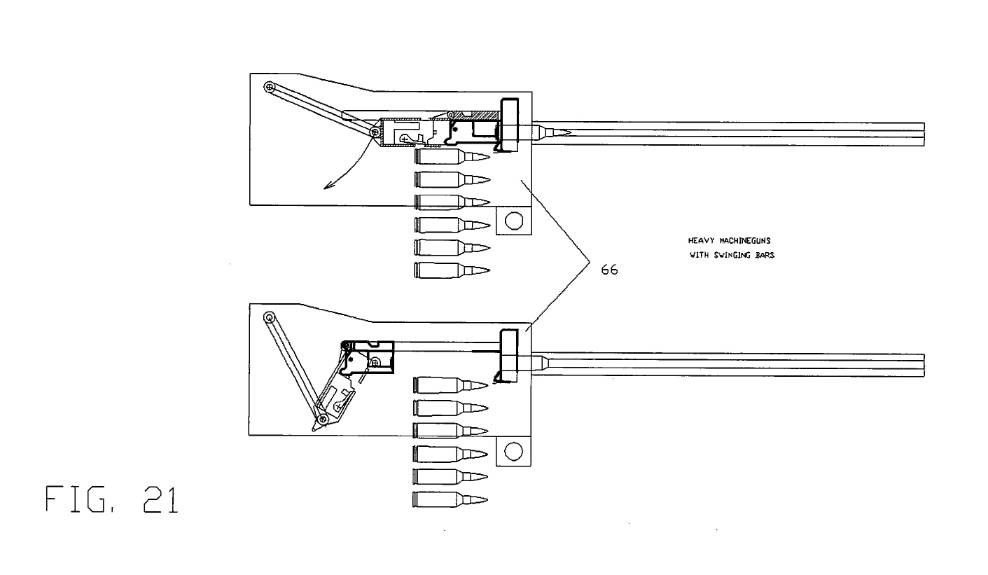

FIG. 21 POSSIBLE USES OF THE BOLT TRAIN IN BELT FED MACHINE GUNS

FIG. 22 SCHEMATIC PLACEMENT OF THE BOLT TRAIN COMPONENTS ON A RIFLE

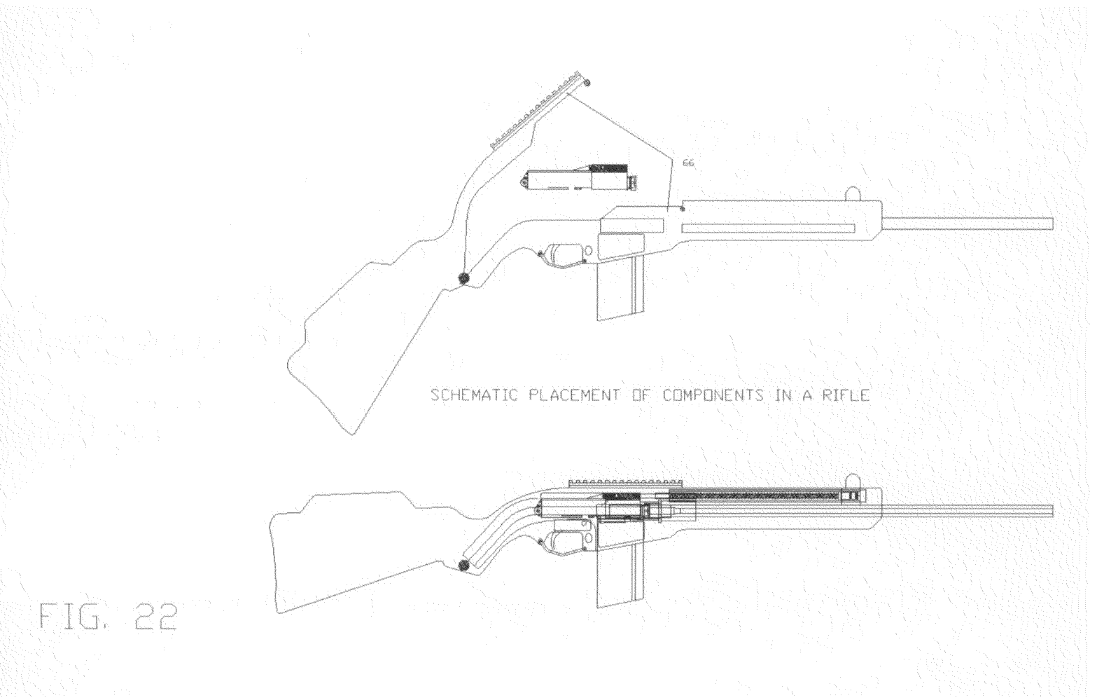

FIG. 23 SCHEMATIC PLACEMENT OF THE BOLT TRAIN COMPONENTS ON A PISTOL

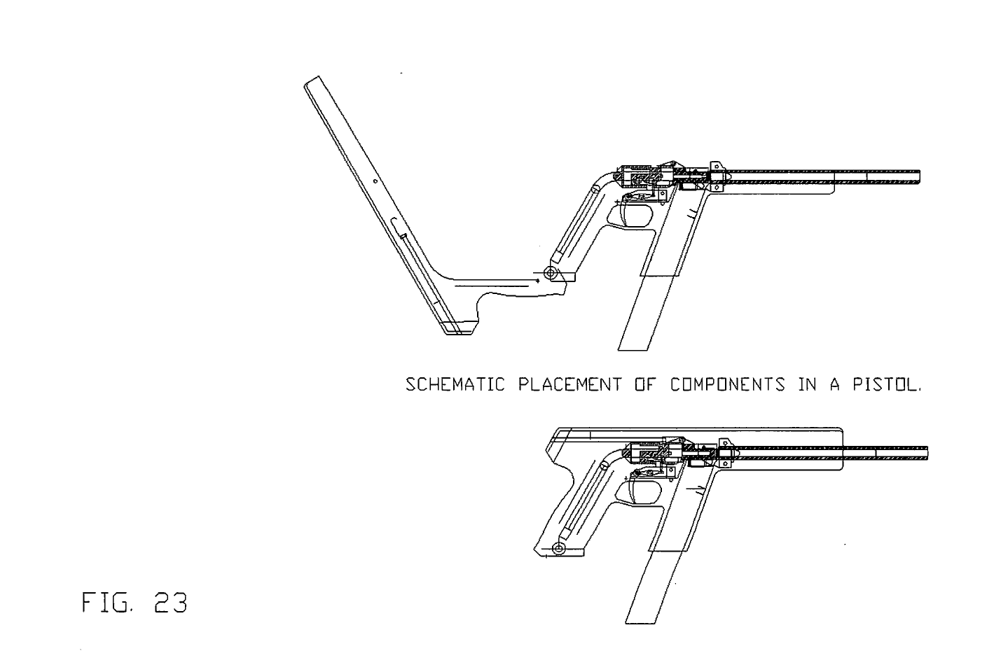

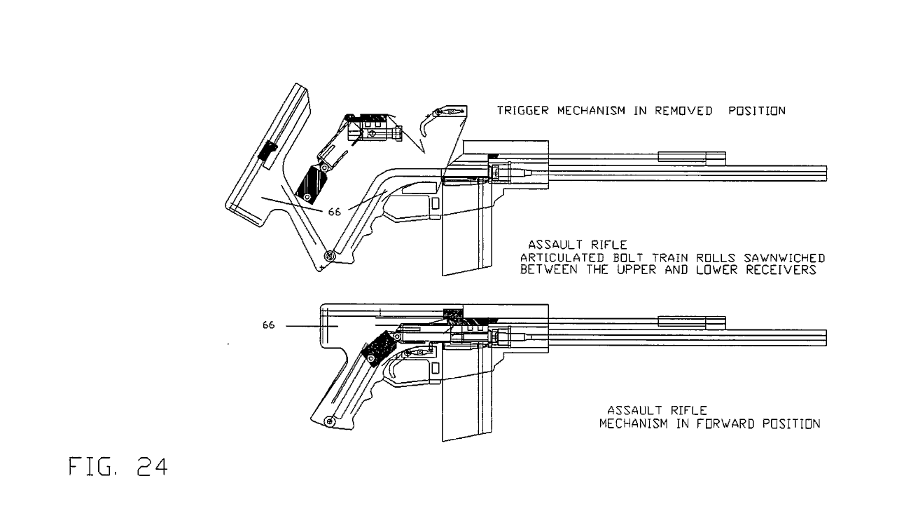

FIG. 24 SCHEMATIC PLACEMENT OF THE BOLT TRAIN COMPONENTS ON AN ASSAULT RIFLE

### PURPOSES, DETAILED DESCRIPTION

My invention has seven different purposes. The first: To provide a Bolt Train mechanism to partially redirect the initial bore axial recoil force into a transversally directed recoil force and to perform several other functions; The second: To provide a firing mechanism subassembly incorporated to the Bolt Train that would displace altogether as part of the recoiling mass; The third: To provide a firing mechanism subassembly incorporated to the Bolt Train 90 that cocks in response to the recoil displacement, and to the angular rotation of the components of the bolt train while displacing rearwards following a transverse path; The fourth: To provide a manageable cam delay blowback mechanism to retard the opening of the breech operating only on rearward motion; The fifth: To significantly reduce the total weight, and volume of the firearm utilizing the Bolt Train mechanism; The sixth: To lower the center of gravity of the firearm utilizing the Bolt Train mechanism; The Seventh: To provide an independent Recoil Damper Mechanism attachable to the Bolt Train sub assembly to additionally restrain the rearwards motion increasing the total delay.

In response to the force needed to propel a projectile on a firearm, the bolt experiments a rearward axial reaction force known as recoil force. In auto loading guns the bolt is forced forward by a recoil counter acting spring, but when the recoil force exceeds that of the spring, the bolt moves rearwards allowing the used cartridge to be expelled, and when cycling back, a new cartridge is moved into the chamber in the reciprocating recovery movement, completing the auto loading cycle: In this process, the force acting on the bolt is axial and is transmitted to the frame creating a kick that, depending on the total mass of the gun, causes a displacement which is perceived as a jump in the gun. Large caliber weapons produce significant recoil upon firing to the point that firing such a weapon poses a significant risk of recoil-induced injury to the shooter when it is not firmly supported. The recoil force experienced by the shooter of a conventional weapon is proportional to the product of the projectile mass, and the acceleration of the projectile by the propelling gases, and inversely proportional to the total mass of the gun. Accordingly, there exists a need for a system that reduces recoil in firearms and weapons.

My invention uses a Bolt Train 90 consisting of two or more track mounted members, pivotally articulately and connected between the adjacent members. The first member of the Bolt Train 90 is a Front Bolt 20, or alternatively a Bolt Carrier 20B containing a Rotary Bolt 20C, which initially travels axially only, The Second member is an Mechanism Carriage Housing 40 or alternatively 40B containing, and including, the Active Firing Mechanisms and progressively diverts its path to a downwards or transverse motion as the front bolt 20 displaces rearwards. When needed, a third optional member is incorporated to the Bolt Train 90. It is a Recoil Damper Subassembly 64, that travels linearly or transversally, comprised of a Recoil damper mechanism carrier 65 containing a movable compensator 67 and a spring 69A. The Bolt Train 90 is track slidably mounted by means of protruding guides 21 or by roller guides 41 or 41A that slide in lateral slot Channel guides 80 embedded or attached to the receiver 66 frame. The slot Channel guides 80 have a path that uniquely directs the displacement of the Bolt Train 90. Because the Firing Mechanism Sub Assembly 39 FIG. 4B, FIG. 5B is articulately linked to the front bolt 20 it always places the firing mechanisms in the closest proximity of the firing pin 70, located inside the front bolt 20. This train array reduces the total weight and the volume, by eliminating the need of having a fixed separate mechanisms subassembly, in other location. The necessary mass to absorb the recoil is present in this transversally recoiling array, but at the same time, is the same mass used in the active firing mechanisms. The mass and volume of the conventional active firing mechanism and its frame are converted into recoiling mass having a very compact volume.

The Articulated Bolt Train 90 is also a kinetic energy multi absorption device.

It accomplishes it in several independent ways:
1. By compressing the main recoil spring.
2. By diverting the path of the Mechanism Carriage Housing 40 and parts contained within. The reaction force of the change of direction is perceived in the receiver as a vertical and rearwards movement.
3. By amplifying the force required to compress the Hammer spring 33 via the principle of mechanism explained in the fourth purpose.
4. By compressing the Hammer spring 33 while cocking as explained in the third purpose.
5. By compressing the Spring 69A, and pushing the Movable Compensator 67 of the optional Recoil Damper Mechanism
6. By utilizing the mass of all the above mentioned mechanisms as working mass to compensate the recoil, saving mass and volume that otherwise would be required to perform the same results in independent mechanisms.

As before mentioned, my invention has Seven different purposes. The first: To provide a Bolt Train mechanism to partially redirect the initial bore axial recoil force into a transversally directed recoil force and to perform several other functions; The second: To provide a firing mechanism subassembly incorporated to the Bolt Train that would displace altogether as part of the recoiling mass; The third: To provide a firing mechanism subassembly incorporated to the Bolt Train 90 that cocks in response to the recoil displacement, and to the angular rotation of the components of the bolt train while displacing rearwards following a transverse path; The fourth: To provide a manageable cam delay blowback mechanism to retard the opening of the breech operating only on rearward motion; The fifth: To significantly reduce the total weight, and volume of the firearm utilizing the Bolt Train mechanism; The sixth: To lower the center of gravity of the firearm utilizing the Bolt Train mechanism; The Seventh: To provide an independent Recoil Damper Mechanism attachable to the Bolt Train sub assembly to additionally restrain the rearwards motion increasing the total delay. Additionally restrain the rearwards motion, increasing the total delay.

Operation

Description of how the Invention Achieves its First Purpose:

To provide a Bolt Train mechanism to partially reroute the initial bore axial recoil force into a transversally directed recoil force and perform several other functions.

In one embodiment the Bolt Train 90 can have a plurality of members interconnected by hinges, or any other proper interlinking means, one after the other that move guided along slot channel guides 80. None of the members is a dead mass, each has a specific function and a mechanism inside the corresponding carrier housing. In order to function properly, the Bolt Train 90 has to be placed inside a by design Receiver 66 that controls and urges its path, and holds all the sub assemblies in the convenient location, allowing the synchronic movements of all the components to take place in time and space. The Receiver 66 is conceived in a manner that it has an Upper receiver and a Lower receiver, so that when both are put together, it will completely define and constrain a plurality of cavities and tracks to enable the unique travel of the Bolt Train 90, and the housing of the modular subassemblies and components of the firearm.

When a firearm is discharged there is a reaction force in the opposite direction of the projectile. That causes the Bolt to displace rearwards over a straight path. In the case of my invention, the bolt is comprised by several articulately linked members that form a Bolt Train 90. The bolt train 90 consists of two or more different bodies. See FIG. 9A, FIG. 10, FIG. 10A. The front bolt 20, and mechanisms carrier housing 40, are connected by a pin 47 that holds together the top displaced hinge 24 of the front bolt 20 and mechanisms carrier housing displaced hinge 48. Hinges 24 and 48 can be displaced outside of the bodies to which they are attached and the center of the hinges holes host pin 47, FIG. 19. The total mass of the bolt train 90 is the sum of the mass of front bolt 20 with all the elements that get attached to it, plus the mass of the mechanisms carrier housing 40 with all the elements that get attached to it and hold inside it (the firing mechanisms).plus the mass of the recoil damper mechanism carrier 64 and all the elements that get attached to it. See FIG. 9A. The Bolt Train 90 is track mounted on slot Channel guide tracks 80 embedded inside the internal sides of the receiver 66 and direct the course (path) in a transverse direction. The Channel guide 80 are internally stamped, embedded or held on the firearm frame. At the moment of firing the cartridge transmits the total recoil force to the bolt train 90. The protruding guides 21 (one at the right other at the left) slide inside the slot Channel guide 80 located on both sides of the cavity where the bolt train 90 moves. Slot Channel guides 80 can be continuous or separated as shown in FIG. 8 and FIG. 8A. The Roller guides 41, which are round, also slide inside the slot Channel guides 80. The slot Channel guides 80 are built to the proper length or may have travel stops to limit the rearwards displacement of the Bolt Train 90. The forward displacement of the front bolt 20 is limited by proper means depending on the design application. The slot Channel guides 80 can be of continuous path as shown on FIG. 8, FIG. 10, FIG. 12 or separate discontinuous paths as shown on FIG. 8A, FIG. 8B, FIG. 10B, FIG. 11, FIG. 12A, FIG. 12C. Due to its design the horizontal protruding guides 21 of front bolt 20, can displace linearly inside the slot Channel guide 80 within the zone A FIG. 8.

Due to the integral design of the bolt train 90, the protruding rod guides 41 or the rollers 41A can move within the zone B, FIG. 8, or FIG. 8A. When the bolt train 90 moves to the back from the forward position, the front bolt 20 displaces linearly, urging the displacement of the mechanisms carrier housing 40 with all contained within (the firing mechanisms) by means of bolt top hinge 24, the mechanisms housing carrier hinge 48, and the connecting pin 47. The latter named parts (24, 48, and 47) interlock the first two bodies (20 and 40) of the Bolt Train, and all the contained components, in an articulated manner that enables the rotation about the connecting pin 47. The mechanisms carrier housing 40 with all the elements contained inside (the firing mechanisms), moves transversally only through the zone B. A conventional main recovery spring needs to be permanently acting on the front bolt 20 either by pushing or by pulling, depending on the design needs, in order to urge the return of the bolt train 90 to the full forward position after it has displaced back and down by the action of the recoil force.

The transverse displacement of the recoiling bolt train 90 changes the direction, and the dynamics of the recoil with respect to traditional bore axis lineal recoiling bolts.

Operation

Description of how the Invention Achieves its Second Purpose:

To provide a firing mechanism subassembly incorporated to the Bolt Train 90 that displaces altogether as part of the recoiling mass.

In one embodiment the firing mechanisms have two different separate types of sub assemblies: The controlling firing mechanisms subassembly 74, FIG. 5C, which has a permanent location, and the Active Firing Mechanism Subassembly 39 FIG. 5B, which moves as a part of the Bolt Train 90.

The lever 76, and the spring column fire actuator, and disconnector 78 all mounted on the frame 79, and the active firing mechanism subassembly 39, FIG. 5B which comprises the hammer, the hammer spring, the sear, sear lever. In conventional designs all of the components of the firing mechanisms are placed together in one subassembly kept in place by a strong frame. The Active Firing Mechanism Subassembly 39, FIG. 5B is located in the closest proximity to the Front Bolt 20, 20a, 20b FIG. 2B, and linked by means of a hinges 48 and 24 in a manner that they become moveable and integrally coupled to the Articulated Bolt Train 90 and fit into a one and only predetermined placement in a synchronized movement at the moment of firing.

The mechanism works in the following way. See FIG. 1. The hammer 30 has the form of a rectangular prism at the rear end it has cylindrical cavity for the spring 31. This hammer has an optional frontal protruding push rod for the firing pin 32. All of it is a single body with no moving parts. The above mentioned parts move freely inside a rectangular cavity 40A of the mechanisms carrier housing 40. Alternatively, an angular sear lever 50 is attached at the top side of the mechanisms carrier housing 40 by means of a pin for sear lever which passes through holes for pin 44 and the hole for sear lever pin 52 of the hinges for sear pin 43 and hole for sear lever hinge pin 52 respectively. The angular sear lever 50 has a small angular face tip 54 that passes through a rectangular hole for the sear tip 45.

A sear lever spring 53 accommodates into the cylindrical hole for sear spring 42 and pushes the angular sear lever 50 so that the angular sear lever 50 is permanently pushed into the rectangular hole for the sear tip 45. The angular face tip 54 is long enough to cause a temporary interference with the frontal face of the hammer 30 retaining it in a cocked loaded position when the hammer 30 is moved enough to the rear inside the rectangular cavity 40A of the mechanisms carrier housing 40 causing the compression of the hammer spring 33.

The rear of the mechanisms carrier housing 40 has two laterally protruding rod guides 41 or Roller guides 41A on to the right, another to the left. They slide along the zone B see FIG. 11 of the Slot Channel guide 80; see FIG. 8. The zone B has a straight part and a curved part adjacent to the zone A. The mechanisms carrier housing 40 connected to the Front Bolt 20 by means of the hinges mechanisms housing carrier hinge 48 and bolt top hinge 24 as previously explained. The mechanisms carrier housing 40 pivots about the connecting pin 47 and connects it (40) with the front bolt 20, constituting on the whole the bolt train 90. The horizontal protruding guides 21 can move linearly inside the slot Channel guide 80 within the zone A FIG. 8. The front bolt 20 and the mechanisms carrier housing 40 are perfectly aligned when the protruding rod guides 41 and the horizontal protruding guides 21 are both in the zone A, This can happen in two situations: when The Bolt Train 90 is in cocked position as described in FIG. 15, and when bolt and firing mechanisms are in forward discharged position as described in FIG. 13. Every time those protruding rod guides 41 are in the zone B, the mechanisms carrier housing 40 and the front bolt 20 are at an angular position pivoting about the connecting pin 47 as shown in FIG. 14. Notice that FIG. 14 is at the extreme position since the horizontal protruding guides 21 is located at the end of zone A. The grouping of the active firing mechanism FIG. 5A inside mechanisms carrier housing 40, is defined as the Active Firing Mechanism Subassembly 39 FIG. 5B. When incorporated to the Bolt Train 90, makes the entire mass to displace when recoiling, fulfilling the purpose.

Operation

Description of how the Invention Achieves its Third Purpose:

To provide a firing mechanism subassembly incorporated to the Bolt Train that cocks in response to the recoil displacement, and to the angular dislocation or misalignment of components of the bolt train while displacing rearwards following a transverse path.

In one embodiment the increasing displacement of the Articulated Bolt Train 90 in the rearward motion causes an increasingly divergent rotation of the Mechanism Carrier Housing 40 about pin 47, increasing the Angle of Articulation FIG. 17A.

The non parallel paths of zone A and zone B of the slot Channel guides 80 FIG. 10 and FIG. 10A, forces the two members of the train to move in different directions crating an angle of articulation center at the top hinge 24, (PIN 47) that progressively increases as the parts displace more along the different paths.

The angle of articulation is defined as shown in FIG. 17A. Relative motions are described.

The cocking action of the firing mechanisms takes place in the following way. As the mechanisms carrier housing 40 starts to move through the zone B, FIG. 8, and FIG. 8A, it starts to rotate about the connecting pin 47, in a manner that the edge line 22A of the thin rear rectangular protrusion 22 describes a circular path about the connecting pin 47, and penetrates inside the rectangular cavity 40A, occupied at this moment by the spring loaded hammer 30, and pushes the hammer 30 towards the back of the rectangular cavity 40A by sliding over the frontal face of the hammer 30. After the hammer 30 passes beyond the sear engagement point, rectangular hole for sear tip 45, the angular face tip 54 of the angular sear lever 50 moves inside the rectangular cavity 40A pushed by the force of the sear lever spring 53 blocking the path of the Hammer 30 and retaining the hammer 30 spring 33. When the bolt train 90 returns forward from the extreme rearward position, the angle of articulation FIG. 17A diminishes, the rear rectangular protrusion 22 moves back reducing the penetration inside the rectangular cavity 40A allowing the hammer 30 to move forward pushed by the force of the compressed spring only to the point that the front face of hammer 34 interferes and contacts the angular face tip 54 locking the firing mechanism in a cocked position. As the Bolt train 90 moves to the aligned position, the protruding rod guides 41 reach the zone A. At this point the hammer 30 is aligned with the front bolt 20 and the firing pin 70 located inside the cylindrical cavity for the firing pin 23. The firing action takes place when the angular sear lever 50 is depressed causing it to pivot about the pin for sear lever 46 raising the angular face tip 54 out of the way of the hammer 30 which moves forward impacting with the push rod of firing pin 32 the rear end of the firing pin 72, which causes the front end of firing pin 73 to strike the primer of the cartridge firing the projectile. On the front bolt 20 there is a rectangular slot 26 to host the placement of a cartridge case extractor 60 which pivots about the extractor pin 61.

It is clear that the recoil force causes the displacement of bolt train 90 rearwards inducing an angular displacement of mechanisms carrier housing 40 and the front bolt 20 about the center of the top hinge 24, which produces the cocking of the active parts of the movable firing mechanism.

Operation

Description of how the Invention Achieves its Fourth Purpose:

To provide a cam delay blowback opening mechanism to retard the opening of the breech.

In one embodiment, my Invention achieves the purpose of creating a delay in the opening of the breech on the rearward motion by generating a restriction to the rearwards motion only, As the recoil force starts to build up it urges the bolt train 90 to move backwards as explained previously. The force opposing to that displacement is that of the main recovery spring of the firearm. An additional force opposing the displacement of the bolt train 90 is crated in the following manner: As the protruding rod guide (2) 41 slidably moves to zone B it starts to rotate about pin 47, as well as the mechanisms carrier housing 40 and the firing mechanisms contained within, causing the protruding delay opening cam 22B of FIG. 1A, 2A to describe a circular path about the center of the top hinge 24, moving inside the rectangular cavity 40A, contacting the delay opening sloped face 35 of front face of hammer 34 of FIG. 1A, 3A as shown in FIG. 13A. The hammer 30 is pushing foreword by the action of the hammer spring 33 of FIG. 1A with a force Fs. To overcome that force, the protruding delay opening cam 22B must exceed a value of force of the equation form F=Fs/cosine of Omega being Omega angle FIG. 3B the one formed by the plane of the front face of hammer 34 and delay opening sloped plane of face 35 as shown more explicitly in FIG. 13A. That is the value of the additional force created by this mechanism and depending on the spring force Fs and the value of the Omega angle FIG. 3B. Once the bolt train 90 progresses into the zone B, the value of that force diminishes as the angle of contact between the protruding delay opening cam 22B and the delay opening sloped face 35 becomes more favorable. The value of the axial force exerted by the front bolt 20 to exceed Fs/cosine of omega depends also of the distance of the protruding rod guide (2) 41 to the pin 47 and other matters. That significant force value is added to the force of the main recovery spring of the firearm, meaning that it will take more time to buildup in the explosion process inside the cartridge, translating into a delay in the opening of the bolt in the recoil. In order to ease the motion and to reduce friction, a roller cam may be used at the protruding delay opening cam 22B. Also rollers can be placed on the side of the hammer 30 in order to smooth the displacement and minimize wear.

Operation

Description of how the Invention Achieves its Fifth Purpose:

to significantly reduce the total weight, and volume of the firearm utilizing the Bolt Train mechanism.

In one embodiment, my Invention achieves the purpose by substituting the conventional fixed placed firing mechanisms by movable firing mechanisms, and placing them and its frame inside the MECHANISMS CARRIER HOUSING 40, behind the Front bolt 20 converting then into a part of the Bolt train 90. The Articulated front Bolt 20 and mechanism carrier housing 40 with firing mechanism incorporated within substitutes the fixed conventional firing mechanisms eliminating the volume and weight that is normally dedicated to it, thus reducing substantially the volume and weight.

The controlling firing mechanisms sub assembly 74 FIG. 5B, FIG. 5C, which comprises trigger, safe, automatic and semi automatic selector, require a small and light structural frame with small volume. It is placed in a convenient predetermined location with the only requirement that, a in order to fire, a pushing element belonging to the firing mechanism can exert a pushing action, to disengage, on the sear 50 or 58, at a unique fixed predetermined location that aligns with the traveler angular sear lever 50 every time that the bolt train 90 is in the full forward position. See FIG. 17. If an internal extruded sear 58 FIG. 5A is utilized, the pushing action of the controlling firing mechanism bar 78 is exerted through a Window Hole 59 of the Mechanism Carrier Housing 40 close to the engaging location of the cylindrical rod sear 58. When the bolt train 90 moves full forward closing the breech, the Window Hole 59 moves to a predetermined position aligning with the pushing bar 78 FIG. 17B of the stationary and compact controlling firing mechanism subassembly 74. This substitution of masses eliminates the volume and mass of the conventional firing mechanisms. The design purpose is possible by identifying masses that can perform dual functions and convert it into a mechanism that serves both functions. The mass present in the hammer, the sear, the mechanisms frame, the hammer spring is used by arranging it into a mechanism that is coupled to the bolt train 90 giving it the necessary mass that needs to be present in the bolt to absorb the recoil.

Operation

Description of how the Invention Achieves its Sixth Purpose:

To lower the center of gravity of the firearm utilizing the Bolt Train 90 assembly.

In one embodiment, the very dense nature and slim profile of the Bolt Train 90 containing the Firing Mechanism enables the substitution of the conventional voluminous firing mechanisms as explained above and placing it in a predetermined location where it will align to interact with the miniature compact controlling firing mechanism subassembly 74, FIG. 5C placed in the closest proximity of the Window Hole 59. FIG. 17B. The compact size of the subassembly 73 lowers the center of gravity.

Operation

Description of how the Invention Achieves its Seventh Purpose:

To provide an independent Recoil Damper mechanism linkedly attachable to the Bolt Train sub assembly to additionally restrain the rearwards motion increasing the total delay.

In one embodiment, when a third member, the Recoil Damper sub assembly 64 FIG. 4C is attached to the Bolt Train 90, it will be positioned at the rear behind of the mechanism carrier housing with rear cam 40B, and linked to it by means of roller with pin 41B passing through the centre hole of the two side hinges 65A and the rear center hole of the mechanism carrier housing with rear cam 40B.

The mechanisms carriage housing 40B has a protruding cam 40C that penetrates through the front of the cavity for compensator 66 where the compensator 67slides freely pushed by the spring 69A. As the Bolt Train 90 moves rearwards, the mechanism carrier housing with rear cam 40B and the Recoil Damper sub assembly 64, initially at an angle, move into a straighter path to align with the transverse axis of the ZONE B FIG. 11A, FIG. 13B and FIG. 14A by pivoting about the Roller with pin 41B. This relative rotation causes the tip of the Protruding cam 40C to describe a circular path inside the cavity for compensator 66 and to slide against the front Angular Face 68 of the Movable Compensator 67, displacing it to the interior of the Recoil damper mechanism carrier 65 and compressing the spring 69A. The action of compressing the spring 69A and pushing the Movable Compensator 67 back at an angle requires a force that opposes to the rearward displacement of the Bolt Train 90 and necessarily delays the opening of the breech, creating an additional retard. It is a kinetic energy storing and absorption device.

### Alternative Embodiments

a. This invention presents a linearly displacing hammer. Similar results in terms of recoil absorption can be obtained by placing a compact array of firing mechanisms with conventional rotary parts behind the front bolt as a part of another type of traveling mechanisms carriage, however it would require more volume, which defeats the purpose of accommodating the traveling mechanisms in a tight space such as the inside of the handgrip.
b. Additional recoil absorption can be achieved by placing conventional shock absorbers, hydraulic or pneumatic, rubber pads at the end of the cavity that receives the mechanisms carrier housing 40. Elastomeric shock absorber can be placed to additionally abate the recoil by allowing the recoiling mechanisms carrier housing 40 stop against them.
c. Neither the mechanisms carrier cavity 40A, the hammer 30, nor the mechanism carriers housing 30 are necessarily rectangular. They are of the convenient shape to accommodate a convenient shaped hammer.
d. FIG. 3B Shows a simpler design of the hammer that incorporates the sear and the sear spring as an integral part of the hammer 30. This locking action takes place internally when the sear angular face 36 moves into the rectangular hole 45B of FIG. 4A at the force of the sear flat spring 37, enabling the elimination of parts numbers 42, 43, 44, 46 50,51, 52,53, 54. Such simpler design of the hammer also makes possible to use a mechanisms carrier housing 40 as shown in FIG. 4B.
e. Slot channel guides 80 are used in this description of the operation, however, other different methods to guide and control the path of the mechanisms may be used without affecting the novelty of this patent.
f. To enhance compactness, the Slot Channel Guides 80 have been shown to be located inside the handle or grip, however, its placement in any other convenient location and with a suitable direction can be used to attain the desired result of recoil management or trimming.
g. FIG. 3C Shows a compact design of the hammer that incorporates an internal articulated toggle internal sear 56 and in a similar way to the latter explained mechanism, has the same benefits, with the advantage of being able to tune the trigger pull sensitivity by using different strength of the toggle internal sear spring 55.
h. A similar active firing mechanism to the one described in this application can be developed to be placed in the Front Bolt location, and operating under the same principles of dislocation of the two main components of the Bolt Train. In this way, the Front Bolt becomes a “Front Bolt and active Firing Mechanisms Carriage Housing”, with active firing mechanisms inside, and the mechanisms carrier housing 40, becomes just a mass with the convenient shape and size. The hammer can integrate with the firing pin, in one sole part.
i. Similar results cad be obtained by substituting the transverse slot Channel tracks that urge the displacement, by articulated bar plates of proper length or plates in which one end of the bar is hinged about a fixed position on the receiver, and at the other end is articulated to a hinge placed at the back of Firing Mechanisms Carriage Housing 40, See FIG. 20. forcing a semi circular motion of the rear end of the Firing Mechanisms Carriage Housing 40.
j. The channel slotted guides can have a convenient form and direction as long as they force the articulation of the Bolt Train Assembly when displacing, can be embedded, stamped, machined slotted in the receiver or separately manufactured and properly attached to the receiver.
k. The receiver 66 can be manufactured by several different processes; machined, stamped, injected, metal injection molding etc; in clam shells, upper and lower receivers, with the condition that when assembled, it will define some cavities and track slots, to accept the necessary parts and subassemblies for its proper functioning.
l. The cocking handle can be placed acting directly on the front bolt or as a part of a bar actuated bi a direct drive gas piston system.
m. A direct drive gas piston system can be used to push back the articulated bolt train upon firing the firearm.
n. When the articulated bolt train is used with large sized projectiles the gun can be fitted with an electric device to assist the drive.
o. The sear can engage in many ways, as long as it locks against the firing mechanisms carriage housing 40, holding the hammer back inside the carriage spring loaded.
p. It is possible to trim, both, the trigger pull, and the trigger travel by placing threaded holes inside the Hammer 30, at the upper side, and the lower side of the cavity that hosts the sear. By placing a spring against the upper part of the seat, exerting trim able force controlled by the displacement of a trimming screw at the opposite side of the threaded hole. The trigger travel is controllable by placing a trim able screw acting over the lower side of the sear, limiting the sear travel to engage, and consequently

Conclusion, Ramifications and Scope

Accordingly, the reader will see that firearms described in one out of the several possible embodiments, will be improved in numerous ways in terms of ergonomy, comfort, recoil control, ease of manufacture, ease to serve, size of the weapon, weight of the weapon, stability, appearance, cost, consealability, and safety due to the simplified technology herein described.

The utilization of composite polymers, carbon fibers and modern manufacturing processes is compatible with the weapons using the present invention.

The potential use of this invention is abundant in nearly all categories of semi and full automatic guns for civilian and military purposes crating a noble class of weapons. Implications in defense are immediate due to the advantages exposed.

What I claim is:

1. A firearm comprising several modular subassemblies, a Barrel, a receiver, an Articulated Bolt Train that alternates between a forward and backward position, an active firing mechanism, a delay blowback method, a controlling firing mechanism, a set of recovery springs, a set off modular multifunctional supports, a buffer mechanism, a Modular Cocking Handle mechanism a direct drive gas system.

2. Said receiver, according to claim 1, explicitly designed to work in cooperation with said Articulated Bolt Train according to claim 1, having an upper receiver, a lower receiver, and eventually a frontal trunnion that when put together define a plurality of cavities to house several pieces, and to totally constrain certain track guides to control an internal path of said Articulated Bolt Train.

3. Said Barrel according to claim 1 has a quick locking and positioning system that interlocks with said modular multifunctional supports according to claim 1, and is attached to said receiver according to claim 2.

4. A method of assembling together said upper receiver, said lower receiver, and eventually said frontal trunnion according to claim 2, that completely defines and constrains sets of said track guides having (a) parallel and (a) divergent courses in different sectors that will control said path of said Articulated Bolt Train according to claim 1, guiding it alternatively between said forward and said backward position, in a manner that it will be increasingly diverting its initial bore axial path into a transversal course when moving towards said backward position.

5. A method of arranging the displacement of said rear portion of said Articulated Bolt Train, according to claim 4, when required, to take place through a passageway in an internal cavity to be found inside the handle, of said receiver according to claim 2.

6. A method of generation stabilizing forces to the firearm when shooting, whereby a reaction force in the receiver is generated, which is perceived by the shooter as a force in the vertical axis of the firearm, as well as generating a precession effect, that serves to control the barrel torque force generated by the rifling of the barrel when shooting, caused by sudden course change of said path of said rear portion of said Articulated Bolt Train, according to claim 5, when forcing said path to describe a circle sector.

7. A method of arranging said upper receiver and said lower receiver so that, when placed together, the partition lines complement each other in the definition and total constrain of said cavities and said track guides, including a partition line along the handle, when necessary, so that a set of rollers or protruding rods of said Articulated Bolt Train, according to claim 2, slide conveniently through said track guides by said divergent paths, sandwiched between said upper receiver and said lower receiver, facilitating the quick assembly and disassembly of the firearm and the transverse displacement of a portion of said Articulated Bolt according to claim 5.

8. An Articulated Bolt Train, comprising several components, capable of following linear and non linear paths, inside said receiver, according to claim 2, consisting of a plurality of articulated links that connect a plurality of components having protruding shapes that accommodate and slide inside said track guides according to claim 2 enabling the controlled reciprocating displacement of said Articulated Bolt Train between said forward position and said backward position according to claim 1.

9. A Front Bolt being the first component of said Articulated Bolt Train according to claim 8 located in the frontal position, having appropriated protruding shapes to slide through said track guides, and having the function of closing the breech of said firearm, according to claim 1, and housing a firing pin, an extractor, an ejector, springs, and having on the rear face a hinge conveniently positioned and a protruding cam conveniently positioned to interact with the second component of said Articulated Bolt Train according to claim 8:in addition said front bolt can house a Rotary Bolt of known art or utilization.

10. An Active Firing Mechanism Carriage, being the second component of said Articulated Bolt Train, according to claim 8, having an opening on the frontal face capable of freely containing the allow the functioning of said Active Firing Mechanism according to claim 1, also having convenient windows and cuts to engage with certain elements of said Active Firing Mechanism, additionally having at the front a hinge conveniently positioned to interlock with said hinge according to claim 9, and additionally having at the rear end a multifunctional shape accommodating a cam, a set of rollers to slide inside said track guides according to claim 8 that also functions as hinge to interact when required, with a third component of said Articulated Bolt Train according to claim 8.

11. Said Active Firing Mechanism, according to claim 10, which moves and accommodated inside said Active Firing Mechanism Carriage, according to claim 10, consisting of a compression spring, a slider striker hammer preferably made of a heavy metal of high specific density like tungsten, and a sprigged sear embedded inside said slider striker hammer, capable of engaging with said convenient windows and cuts according to claim 10, and said sprigged sear having a protrusion to interact with the controlling firing mechanism according to claim 1.

12. A delay blowback method operating by the interaction of said protruding cam according to claim 9 that slides against the frontal face of said slider striker hammer according to claim 11 that has a cut which provides an inclined plane and presents the effect of a multiplied force to said compression spring pushing back said slider striker hammer, according to claim 11, at the commencement of said backward motion according to claim 8, causing that said Articulated Bolt Train, according to claim 8, can only displace when the force caused by the increasing pressure inside the barrel overcomes said multiplied force, delaying the breech opening.

13. Said Articulated Bolt train, according to claim 1, comprising said Active Firing Mechanism According to claim 11 which cocks in response to the articulation of said Front Bolt, according to claim 9 and said Active Firing Mechanism Carriage, according to claim 10, causing the incursion of the lower rear part of said Active Firing Mechanism Carriage, according to claim 9, through said opening on the frontal face, according to claim 10, displacing said spring loaded slider striker hammer, according to claim 11, towards the rear a distance sufficient to allow the engagement of said sprigged sear, according to claim 11, with said windows and cuts in predetermined position, according to claim 10, while it moves along said divergent courses, according to claim 4, when displacing in said backward position according to claim 8.

14. Said Controlling Firing Mechanism according to claim 1 consisting of a frame, a trigger, a lever and a flexible actuator conveniently located to interact in a predetermined position with said protrusion of said sear according to claim 11 in order to liberate the engagement of said sear against said window or cut on said Active Firing Mechanism Carriage according to claim 10.

15. Said set of recovery springs, according to claim 1, conveniently accommodated pre compressed inside said upper receiver, according to claim 2, that interlock with said Articulated Bolt Train, according to claim 8, preferably with said Front Bolt, according to claim 9, by means of a slider coupling part, only when said upper receiver and said lower receiver, according to claim 7, are placed together sandwiching said Articulated Bolt Train, according to claim 8.

16. Said set of multifunctional modular supports, according to claim 1, independent or embedded to said upper or lower receivers, according to claim 2, having several functions including to provide a ramp for the cartridges to travel from a magazine to the barrel chamber, aligning said barrel, affixing said barrel, allowing the quick locking and change of said barrel, according to claim 1, allowing the firm coupling and fastening of said upper and lower receivers, according to claim 2, supporting said Modular Cocking Handle mechanism, according to claim 1.

17. Said buffer mechanism according to claim 1, resulting from the interaction of said cam at the rear of said Active Firing Mechanism Carriage, according to claim 10, and a spring loaded piston that moves freely linearly inside a carriage, the third component of said Articulated Bolt Train, according to claim 8, resulting in compression of a dampening spring positioned at the rear end of said carriage when said carriages articulate to follow a less divergent path.
